(19) United States
(12) Patent Application Publication
(10) Pub. No.: US 2022/0174067 A1
(43) Pub. Date: Jun. 2, 2022

(54) SECURING DATA AND TRACKING ACTIONS UPON DATA

(71) Applicant: Covax Data, Inc., Tucson, AZ (US)

(72) Inventors: Christopher Hawkinson, Tucson, AZ (US); Jason Saslow, Tucson, AZ (US); Brandon Hawkinson, Tucson, AZ (US)

(73) Assignee: Covax Data, Inc., Tucson, AZ (US)

(21) Appl. No.: 17/535,783

(22) Filed: Nov. 26, 2021

Related U.S. Application Data
(60) Provisional application No. 63/118,812, filed on Nov. 27, 2020.

(51) Int. Cl. H04L 9/40

(52) U.S. Cl. CPC H04L 63/101; H04L 63/0876; H04L 63/20; H04L 63/08; H04L 63/061; H04L 63/126

(57) ABSTRACT

Methods and systems for securing data and tracking actions upon data. The systems may include one or more access points each including a driver, a storage system including one or more protected containers, an authentication system, a time stamp authority, an artificial intelligence and/or machine learning system, and/or third party systems. The methods may include commissioning or activating a driver of an access point, approving access for a user of an access point, commissioning a new protected container, approving user access to protected data in a protected container of the storage system, retrieving and decrypting the protected data, recording a retrieval indication in a chain of custody ledger of the protected container, and/or providing the user with access to protected data.

### CROSS-REFERENCE TO RELATED APPLICATION

The present application claims the benefit of priority to U.S. Provisional Application Ser. No. 63/118,812, filed on Nov. 27, 2020, which is incorporated herein by reference in its entirety.

### BACKGROUND

### Field of Invention

Aspects of the present invention relate to securing data and tracking actions upon data.

### Discussion of the Background

Conventional data security systems do not actually protect the data itself and instead focus on functions such as end-point protection, network monitoring, firewalls, and antivirus that daily prove to be inadequate. In contrast, the Polymer platform provides complete control of the data at the data level—the ultimate end-point.

### SUMMARY

Aspects of the invention may address one or more shortcomings of conventional data security systems by providing complete control of protected data at the data level.

One aspect of the present invention relates to a method performed by a driver of a computer system. The method may include commissioning the driver. The commissioning may include receiving a driver commission identifier conveyed by an authentication system. The method may include receiving a user access request from a user. The user access request may include user credentials, and the user credentials may include a username. The method may include, in response to receiving the user access request, conveying the username and the driver commission identifier to the authentication system. The method may include receiving a user access approval indication conveyed by the authentication system. The user access approval indication may include a session token. The method may include receiving a protected data request from the user. The protected data request may relate to content of a protected container, the protected data request may include an identification of the protected container, and the protected container may include a chain of custody ledger. The method may include conveying the session token and the identification of the protected container to the authentication system. The method may include receiving a protected data request approval indication conveyed by the authentication system. The method may include retrieving the content of the protected container to which the protected data request relates from a data storage system. The method may include decrypting the retrieved content. The method may include recording a retrieval indication in the chain of custody ledger of the protected container from which the content is retrieved. The method may include providing the user with access to decrypted content.

In some embodiments, commissioning the driver may further include receiving a commission request including a username of a driver commissioning requester. In some embodiments, commissioning the driver may further include, in response to receiving the commission request, conveying the username of the driver commissioning requester to the authentication system. In some embodiments, commissioning the driver may further include receiving a public key conveyed by the authentication system, and the public key may be unique to the driver commission identifier. In some embodiments, commissioning the driver may further include encrypting a packet using the public key and conveying the encrypted packet to the authentication system, and the packet may include the username of the commission requester, a hardware identifier that uniquely identifies the computer system, and the driver commission identifier. In some embodiments, commissioning the driver may further include creating a new public key and a new private key for the driver, and the packet may further include the new public key. In some embodiments, commissioning the driver may further include receiving a commissioning approval indication conveyed by the authentication system. In some embodiments, the commissioning approval indication may be a first commissioning approval indication including a one-time authentication secret, commissioning the driver may further include using the one-time authentication secret to generate an authentication code, conveying a second packet to the authentication system, and receiving a second commissioning approval indication conveyed by the authentication system. In some embodiments, the second packet may include the hardware identifier, the driver commission identifier, and the authentication code.

In some embodiments, the user credentials of the user access request may include one or more of a password and an authentication code. In some embodiments, the user credentials of the access request may include the authentication code, and the authentication code may be a multifactor authentication code.

In some embodiments, the method may further comprise creating a password hash using the user credentials of the user access request and conveying the password hash with the username and the driver commission identifier. In some embodiments, the received user access approval indication may further include a session expiration time. In some embodiments, the received user access approval indication may further include an identification of the user. In some embodiments, the protected data request approval indication may include a passphrase of the protected container, and decrypting the retrieved content may include using the passphrase of the protected container to decrypt the retrieved content. In some embodiments, the protected data request approval indication may include access rights and permissions to the protected container.

In some embodiments, the method may include creating a protected data request hash of one or more details of the protected data request and conveying the session token, the protected data request hash, and the details of the protected data request to a time stamp authority (TSA) system. In some embodiments, the details of the protected data request may include a request type and the identification of the protected container. In some embodiments, the details of the protected data request may include an identification of the user, a one-time authentication code, the session token, and/or the driver commission identifier. In some embodiments, the method may further include receiving a timestamp and a signature conveyed by the TSA. In some embodiments, the retrieval indication recorded in the chain of custody ledger of the protected container may include the timestamp and the signature. In some embodiments, the retrieval indication recorded in the chain of custody ledger of the protected container may include the identification of the user. In some embodiments, the retrieval indication recorded in the chain of custody ledger of the protected container may include the details of the protected data request. In some embodiments, the retrieval indication recorded in the chain of custody ledger of the protected container may include the hash of the one or more details of the protected data request.

In some embodiments, the protected container may include raw data and associated metadata. In some embodiments, the protected containers may include sub-containers. In some embodiments, the protected data request may relate to content of one or more of the sub-containers. In some embodiments, the protected container may include an identification of the protected container.

In some embodiments, the method may further include commissioning a new protected container. In some embodiments, commissioning the protected container may include receiving a new protected container commission request from a new protected container commissioning requester, and the new protected container commission request includes a username of the protected container commissioning requester. In some embodiments, commissioning the protected container may include, in response to receiving the new protected container commission request, conveying the username of the new protected container commissioning requester to the authentication system. In some embodiments, commissioning the protected container may include receiving a container commission identifier conveyed by the authentication system, and the container commission identifier may be associated with commissioning the new protected container. In some embodiments, commissioning the protected container may include creating a new public key and a new private key for the new protected container. In some embodiments, commissioning the protected container may include creating a new protected container commissioning packet including the username of the new protected container commissioning requester, the container commission identifier, and the new public key for the new protected container. In some embodiments, commissioning the protected container may include conveying the new protected container commissioning packet to the authentication system. In some embodiments, commissioning the protected container may include receiving a new protected container approval indication conveyed by the authentication system.

In some embodiments, creating the new protected container commissioning packet may include encrypting at least the new public key for the new protected container. In some embodiments, the new protected container commissioning packet may include a passphrase. In some embodiments, commissioning the protected container may further include receiving the passphrase from the new protected container commissioning requester. In some embodiments, commissioning the protected container may further include determining that the new protected container commission request did not include a passphrase and creating the passphrase.

In some embodiments, the protected data request approval indication may include the passphrase, and decrypting the retrieved content may include using the passphrase to decrypt the retrieved content.

In some embodiments, commissioning the protected container may further include creating an identification for the new protected container, and the identification for the new protected container may uniquely identify the new protected container. In some embodiments, commissioning the protected container may further include conveying a second new protected container commissioning packet to the authentication system, and the second new protected container commissioning packet may include the identification for the new protected container.

In some embodiments, the new protected container approval indication may include a one-time authentication secret, commissioning the protected container may further include generating an authentication code using the one-time authentication secret, and the second new protected container commissioning packet may further include the authentication code. In some embodiments, the method may further include conveying the authentication code to the authentication system with the session token and the unique identifier of the protected container. In some embodiments, the second new protected container commissioning packet may further include the container commission identifier. In some embodiments, the new protected container approval indication may be a first new protected container approval indication, and commissioning the driver may further include receiving a second new protected container approval indication conveyed by the authentication system. In some embodiments, the driver may be a software module that provides an interface from a file system of an operating system of the computer system to the data storage system that stores the protected container.

Another aspect of the present invention relates to a computer system adapted to commission a driver, and commissioning the driver may include receiving a driver commission identifier conveyed by an authentication system. The computer system may be adapted to receive a user access request from a user, the user access request may include user credentials, and the user credentials may include a username. The computer system may be adapted to, in response to receiving the user access request, convey the username and the driver commission identifier to the authentication system. The computer system may be adapted to receive a user access approval indication conveyed by the authentication system, and the user access approval indication may include a session token. The computer system may be adapted to receive a protected data request from the user, the protected data request may relate to content of a protected container, the protected data request may include an identification of the protected container, and the protected container may include a chain of custody ledger. The computer system may be adapted to convey the session token and the identification of the protected container to the authentication system. The computer system may be adapted to receive a protected data request approval indication conveyed by the authentication system. The computer system may be adapted to retrieve the content of the protected container to which the protected data request relates from a data storage system. The computer system may be adapted to decrypt the retrieved content. The computer system may be adapted to record a retrieval indication in the chain of custody ledger of the protected container from which the content is retrieved. The computer system may be adapted to provide the user with access to decrypted content.

Still another aspect of the present invention relates to a method performed by an authentication system. The method may include conveying a driver commission identifier to a driver of a computer system. The method may include receiving a user access request conveyed by the driver of the computer system. The user access request may include user credentials of a user access requester and the driver commission identifier, and the user credentials may include a username of the user access requester. The method may include determining that the user credentials of the user access requester are authentic. The method may include, in response to determining that the user credentials are authentic, creating a session token and conveying a user access approval indication to the driver of the computer system, and the user access approval indication may include the session token. The method may include receiving a protected data request conveyed by the driver of the computer system, and the protected data request may include an identification of the user access requester, the session token, and an identification of a protected container. The method may include determining to approve the protected data request. Determining to approve the protected data request may include determining that the session token of the received protected data request is active and determining that the user access requester has permission to make the protected data request, and the identification of the user access requester and the identification of the protected container may be used to determine that the user access requester has permission to make the protected data request. The method may include, in response to determining to approve the protected data request, conveying a protected data request approval indication to the driver of the computer system.

In some embodiments, the method may further include receiving a username of a driver commissioning requester from the driver of the computer system, determining that the username of the driver commissioning requester is valid, determining that the driver commissioning requester has authority to commission the driver of the computer system, and, in response to determining that the username of the driver commissioning requester is valid and that the driver commissioning requester has authority to commission the driver of the computer system, generating the driver commission identifier and conveying the driver commission identifier to the driver of the computer system. In some embodiments, determining that the username of the driver commissioning requester is valid may include comparing the username of the driver commissioning requester to a list of valid usernames and/or determining the username of the driver commissioning requester to be associated with the computer system on which a driver commission request is being made. In some embodiments, the method may further include generating a public key and private key pair and conveying the public key to the driver of the computer system, and the public key may be unique to the driver commission identifier. In some embodiments, the method may further include receiving an encrypted packet conveyed by the driver of the computer system and decrypting the encrypted packet using the private key, and the encrypted packet may include the username of the driver commission requester, a hardware identifier that uniquely identifies the computer system, and the driver commission identifier. In some embodiments, the encrypted packet may further include a public key unique to the driver of the computer system.

In some embodiments, the method may further include conveying a commissioning approval indication to the driver commission requester. In some embodiments, the commissioning approval indication may be a first commissioning approval indication including a one-time authentication secret. The method may further include receiving a packet conveyed by the driver of the computer system, and the packet may include an authentication code generated using the one-time authentication secret, the hardware identifier, and the driver commission identifier. The method may further include validating the authentication code, the hardware identifier, and the driver commission identifier and, in response to validating the authentication code, the hardware identifier, and the driver commission identifier, conveying a second commissioning approval indication to the driver of the computer system.

In some embodiments, the user credentials of the user access requester may include one or more of a password and an authentication code. In some embodiments, the user credentials of the access request may include the authentication code, and the authentication code may be a multifactor authentication code. In some embodiments, determining that the user credentials of the user access requester are authentic may include verifying the password and/or the authentication code.

In some embodiments, the user access approval indication may further include a session expiration time. In some embodiments, the user access approval indication may further include an identification of the user access requester. In some embodiments, the protected data request approval indication may include a passphrase of the protected container. In some embodiments, the protected data request approval indication may include access rights and permissions to the protected container. In some embodiments, determining that the user access requester has permission to make the protected data request may include retrieving permissions of the protected container identified by the identification of the protected container, and determining that the user access requester has permission to make the protected data request may include using the identification of the user access requester and the permissions of the protected container to determine that the user access requester has permission to make the protected data request.

In some embodiments, the protected data request may include an identification of the driver of the computer system, and determining to approve the protected data request may further include determining that the driver of the computer system has permission to make the protected data request. In some embodiments, determining that the driver of the computer system has permission to make the protected data request may include retrieving permissions of the protected container identified by the identification of the protected container, and determining that the driver of the computer system has permission to make the protected data request may include using the identification of the driver and the permissions of the protected container to determine that the driver of the computer system has permission to make the protected data request.

In some embodiments, determining to approve the protected data request may further include conveying details of the user access requester, the protected data request, and/or the driver of the computer system to an artificial intelligence and/or machine learning (AI/ML) system and receiving a risk level indication conveyed by the AI/ML system, and the risk level indication may indicate a risk level associated with the protected data request. In some embodiments, the method may further include using the AI/ML system to determine the risk level, and determining the risk level may include receiving data requester behavior metrics from the driver of the computer system, writing the data requester behavior metrics to a database of the AI/ML, and processing the data requester behavior metrics using one or more AI/ML algorithms. In some embodiments, determining to approve the protected data request may further include comparing the received risk level indication against the acceptable risk levels to determine that the protected data request falls within acceptable risk parameters. In some embodiments, the user access approval indication may further include a session duration based on the received risk level indication.

In some embodiments, the protected data request may further include a protected data request hash, and determining to approve the protected data request may further include: creating a hash of one or more of the details of the protected data request and determining that the created hash matches the protected data request hash. In some embodiments, the user access request may include a password hash, and determining that the user credentials of the user access requester are authentic may include: creating a password hash using the user credentials of the user access request and determining that the created password hash matches the password hash of the user access request. In some embodiments, the user access request may include a one-time authentication code.

Still another aspect of the present invention relates to an authentication system. The authentication system may be adapted to convey a driver commission identifier to a driver of a computer system. The authentication system may be adapted to receive a user access request conveyed by the driver of the computer system, the user access request may include user credentials of a user access requester and the driver commission identifier, and the user credentials may include a username of the user access requester. The authentication system may be adapted to determine that the user credentials of the user access requester are authentic. The authentication system may be adapted to, in response to determining that the user credentials are authentic, create a session token and convey a user access approval indication to the driver of the computer system, and the user access approval indication may include the session token. The authentication system may be adapted to receive a protected data request conveyed by the driver of the computer system, and the protected data request may include an identification of the user access requester, the session token, and an identification of a protected container. The authentication system may be adapted to determine to approve the protected data request, and determining to approve the protected data request may include: determining that the received session token is active and determining that the user access requester has permission to make the protected data request, and the identification of the user access requester and the identification of the protected container may be used to determine that the user access requester has permission to make the protected data request. The authentication system may be adapted to, in response to determining to approve the protected data request, convey a protected data request approval indication to the driver of the computer system.

Yet another aspect of the present invention relates to a computer program including instructions for adapting an apparatus to perform any of the methods described above. Still another aspect of the present invention relates to a carrier containing the computer program, and the carrier may be one of an electronic signal, optical signal, radio signal, or computer readable storage medium.

Yet another aspect of the present invention relates to an apparatus including processing circuitry and a memory, and the memory may contain instructions executable by the processing circuitry, whereby said apparatus is operative to perform any of the methods described above.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting aspects of the present invention. In the drawings, like reference numbers indicate identical or functionally similar elements.

FIG. 1 is a block diagram illustrating a system for securing data and tracking actions upon data embodying aspects of the present invention.

FIGS. 2A and 2B are block diagrams illustrating examples of protected containers embodying aspects of the present invention.

FIG. 3 is a block diagram of an apparatus embodying aspects of the present invention.

FIG. 4 is a flow chart illustrating a process for securing data and tracking actions upon data embodying aspects of the present invention.

FIG. 5 is a flow chart illustrating a process for commissioning or activating a driver of an access point embodying aspects of the present invention.

FIG. 6 is a flow chart illustrating a process for commissioning or activating a driver of an access point embodying aspects of the present invention.

FIG. 7 is a flow chart illustrating a login process for approving or denying user access embodying aspects of the present invention.

FIG. 8 is a flow chart illustrating a login process for approving or denying user access embodying aspects of the present invention.

FIG. 9 is a flow chart illustrating a new protected container commissioning process embodying aspects of the present invention.

FIG. 10 is a flow chart illustrating a new protected container commissioning process embodying aspects of the present invention.

FIG. 11 is a flow chart illustrating a protected data accessing process embodying aspects of the present invention.

FIG. 12 is a flow chart illustrating a protected data accessing process embodying aspects of the present invention.

FIG. 13 is a flow chart illustrating a protected data accessing process embodying aspects of the present invention.

### DETAILED DESCRIPTION

While the present invention may be embodied in many different forms, a number of illustrative aspects are described herein with the understanding that the present disclosure is to be considered as providing examples of the principles of the invention and such examples are not intended to limit the invention to preferred aspects described herein and/or illustrated herein.

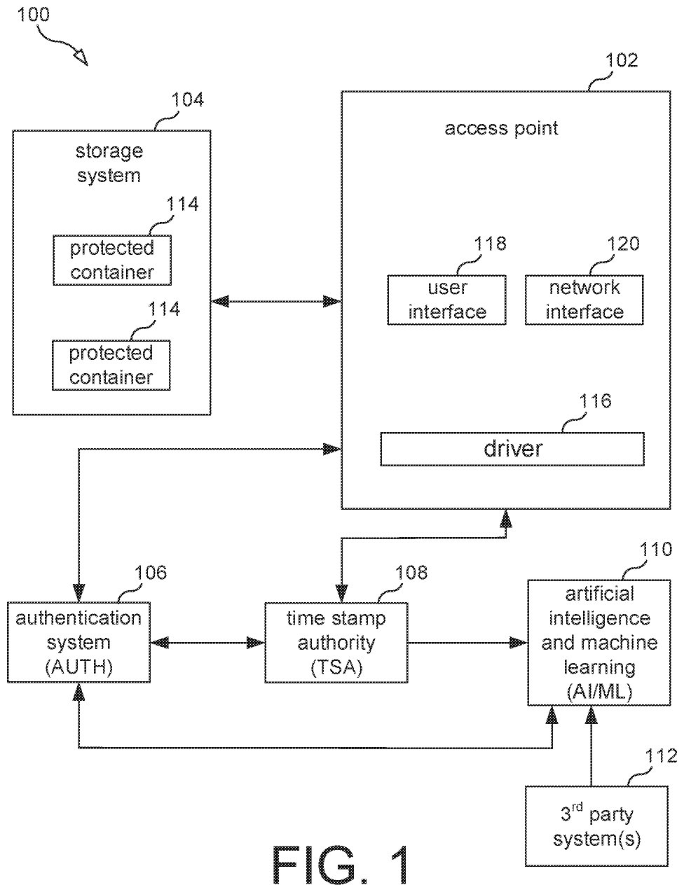

FIG. 1 illustrates a system 100 for securing data and tracking actions upon data embodying aspects of the present invention. In some embodiments, the data securing and action tracking system 100 may include an access point 102, a storage system 104, an authentication system (AUTH) 106, a time stamp authority (TSA) system 108, an artificial intelligence and/or machine learning (AI/ML) system 110, and/or one or more third party systems 112. Although only one access point 102 is illustrated in FIG. 1, in some embodiments, the data securing and action tracking system 100 may include multiple access points 102. In some embodiments, the storage system 104 may include one or more protected containers 114.

In some embodiments, an access point 102 may be a computer system such as, for example, a personal computer or a server. In some embodiments, the computer system may be a physical or virtual device. In some embodiments, the access point 102 may include a driver 116. In some embodiments, the driver 116 may be a system level module. In some embodiments, the driver 116 may be a software module that provides an interface from a file system of an operating system of the access point 102 to the data storage system 116 that stores protected containers 114. In some embodiments, the driver 116 may be installed on the access point 102.

In some embodiments, the access point 102 may include a user interface 118 and/or a network interface 120. In some embodiments, the user interface 118 may include one or more components (e.g., one or more displays and/or one or more speakers) for conveying information to the user and/or one or more components (e.g., one or more user inputs such as, for example, a keyboard, mouse, and/or microphone). In some embodiments, the network interface 120 may include a transmitter and a receiver for enabling the access point 102 to transmit data to and receive data from other nodes (e.g., the storage system 104, AUTH 106, TSA system 108, AI/ML system 110, and/or one or more third party systems 112) connected to a network (e.g., an Internet Protocol (IP) network) to which the network interface 120 is connected.

In some embodiments, the system 100 may use encryption to protect the data in the one or more protected containers 114 of the storage system 104. In some embodiments, a driver 116 of an access point 102 may encrypt and/or decrypt data as needed and read and/or write to a file system of an operating system of the access point 102 and/or to a protected container 114 of the storage system 104 as needed. In some embodiments, each driver 116 may have an identification (e.g., a unique identification such as a universally unique identification (UUID) or a globally unique identification (GUID)), and the driver identification may allow all actions taken through that driver 116 to be tracked. The driver 116 may authenticate users and/or actions using the AUTH 106 and/or may record user actions using the TSA system 108.

In some embodiments, the system 100 may secure data by creating one or more protected containers 114. In some embodiments, the one or more protected containers 114 may contain raw data and associated metadata. In some embodiments, the one or more protected containers 114 may be of any size and/or of any data type that is supported by the operating and file/storage systems of the access points 102 on which the drivers 116 are deployed.

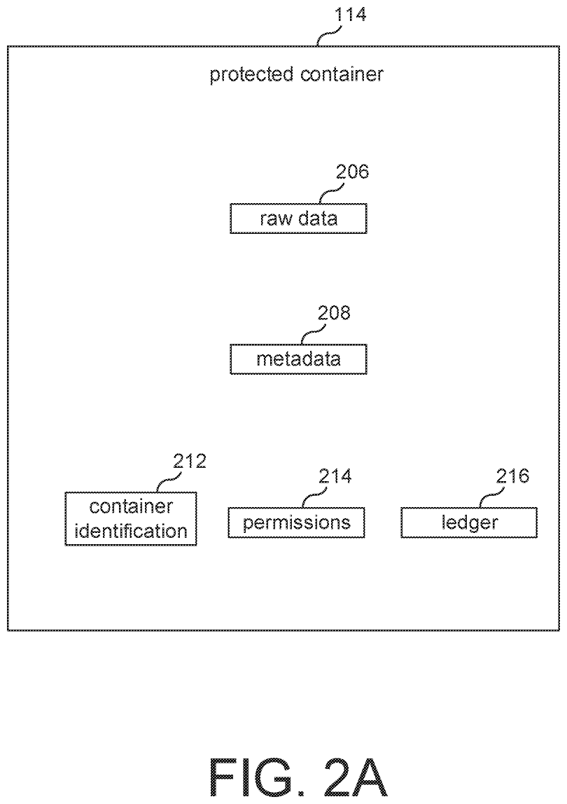

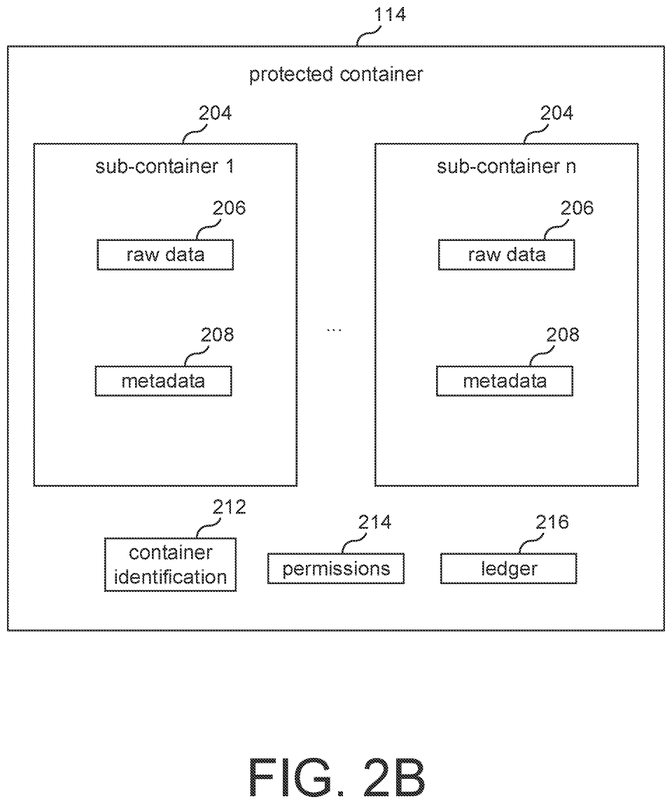

FIGS. 2A and 2B are block diagrams of examples of protected containers 114 according to some embodiments. In some embodiments, as shown in FIG. 2A, the protected container 114 may include raw data 206 and/or metadata 208. In some embodiments, as shown in FIG. 2B, the protected container 114 may include one or more sub-containers 204. In some embodiments, the protected container 114 may be broken into the smaller sub-containers 204 based on the size of the data in the protected container 114. In some embodiments, a sub-container 204 may include raw data 206 and/or metadata 208. In some embodiments, the raw data 206 and/or the metadata 208 may be encrypted (e.g., using a passphrase for the protected container 114 or a derivative of the passphrase).

In some embodiments, as shown in FIGS. 2A and 2B, the protected container 114 may include a container identification 212, permissions 214, and/or a chain of custody ledger 216. In some embodiments, the container identification 212 may be a universally unique identification (UUID) or a globally unique identification (GUID). In some embodiments, the permissions 214 may identify one or more users allowed to access the protected container 114 (e.g., by including a list of identifications of users allowed to access the protected container 114) and/or one or more drivers 116 of access points 102 allowed to access the protected container 114 (e.g., by including a list of drivers 116 allowed to access the protected container 114).

In some embodiments, the permissions 214 may secure data by permitting users and/or administrators to set permissions, which may restrict every aspect of the data interaction. In some embodiments, a user may set the permissions 214 for a protected container 114 upon creation of the protected container 114, and a user may be able to edit those permissions 214 throughout the life of the protected container 114. In some embodiments, the permissions 214 may include restrictions such as which individuals or groups can access the secured data, what actions those individuals or groups can perform (e.g. read only, read-write, etc.), which individuals can search for and/or see the protected container 114, when and/or where the protected container 114 can be accessed, and/or any compliance regulations or restrictions that must be applied to the data within the protected container 114 or to the protected container 114 itself. In some embodiments, administrators may be able to set permissions in the same way as users, or by configuring the interaction between the system 100 and the third-party software application consuming the protected data, as well as restricting users' ability to change permissions 214.

In some embodiments, access to a protected container 114 may require a driver 116. In some embodiments, access to the driver 116 may be controlled by assigning each driver 116 a commission (i.e., requiring an activation process). In some embodiments, the driver 116 may require user credentials of a user to be authenticated by the AUTH 106 before the user is granted access. In some embodiments, the user credentials may include, for example and without limitation, a username, password, and/or authentication code (e.g., multifactor authentication code). In some embodiments, the authentication code may be created with the user of the system is provisioned. In some embodiments, the user may be given an authentication secret, and the authentication secret may periodically generate a new password (e.g., every 30 seconds). In some embodiments where the authentication code is a multifactor authentication code, the factors or the multifactor authentication code may include, for example and without limitation, one or more of facial recognition, fingerprint sensors, optical sensors, other biometric sensors, one time passwords, and/or hardware keys.

In some embodiments, an identification of the user (e.g., a unique identification such as a UUID or a GUID) may be used. In some embodiments, a driver 116 may transmit to the AUTH 106 a username, password, and/or authentication code (e.g., in an encrypted packet). In some embodiments, the driver 116 may receive approval or denial for the user's request for access to the driver 116 from the AUTH 106. In some embodiments, the AUTH 106 may create a session token for an approved user, and the session token may provide the user with access to the driver 116.

In some embodiments, the user that has received access approval may then make a specific request for protected data (e.g., either for a protected data in a specific protected container 114 or for a specific data set of the protected container 114). In some embodiments, the driver 116 may communicate the details of the request to the TSA system 108. In some embodiments, the driver 116 may then receive a timestamp and signature from the TSA system 108 and record in a retrieval indication in the chain of custody ledger 216 of the protected container 114. In some embodiments, the retrieval indication may include the timestamp and the signature received from the TSA system 108. In some embodiments, the retrieval indication may additionally include identification of the user who has requested the protected data, the details of the protected data request, and/or a hash of the one or more details of the protected data request. In some embodiments, the chain of custody ledger 216, recordation of the retrieval indication, and/or operation of the TSA system 108 may include one or more details of the chain-of-custody for archived data described in U.S. Pat. No. 9,122,729, which is incorporated by reference herein in its entirety.

In some embodiments, the driver 116 may also communicate the details of the request to the AUTH 106, and the AUTH 106 may provide the driver 116 with approval or denial of the protected data request. In some embodiments, the AUTH 106 may be responsible for verifying the presence of an active session token at the driver 116, the requestor's permissions regarding the specific request, the permissions of the requesting driver 116, and/or input from the AI/ML system 110. In some embodiments, the driver 116, upon receiving approval from AUTH 106 may then allow the user to begin consuming the protected data by decrypting and reading the data as needed and/or encrypting and writing the data to/from the file or storage system 104 as needed. These actions may be recorded by the driver 116 and inserted in an asynchronous manner into the ledgers 216 of the protected containers 114.

In some embodiments, the AI/ML system 110 may consume and analyze data to determine a risk level indication with respect to the authenticity, virtuousness, and/or legitimacy of a requestor and a protected data request. In some embodiments, the AI/ML system 110 may receive data points from one or more drivers 116, the AUTH 106, the TSA system 198, and/or other third-party systems 112. In some embodiments, the AI/ML system 110 may classify, parse, and/or analyze data to create algorithms used to scrutinize the requestor, protected data request, and actions taken by the requestor after access has been granted and determine the risk level indication that the AI/ML system 110 provides to the AUTH 106. In some embodiments, in determining the risk level, the AI/ML system 110 may include receiving data requester behavior metrics from the driver 116 of the access point 102, writing the data requester behavior metrics to a database of the AI/ML system 110, and processing the data requester behavior metrics using one or more AI/ML algorithms. In some embodiments, the AUTH 106 may use the risk level indication when determining whether to approve a protected data request.

In some embodiments, the driver 116 may include an executable digital shredder that ensures secure deletion of a protected content from the access point 102 by completely sanitizing the digital record. In some embodiments, the shredder may be configured to delete a protected content by truncating the file size to zero, randomly renaming the file, and/or randomly overwriting the data of the file(s) many times to render the data unrecoverable. In some embodiments, the shredder may be controlled by the driver 116.

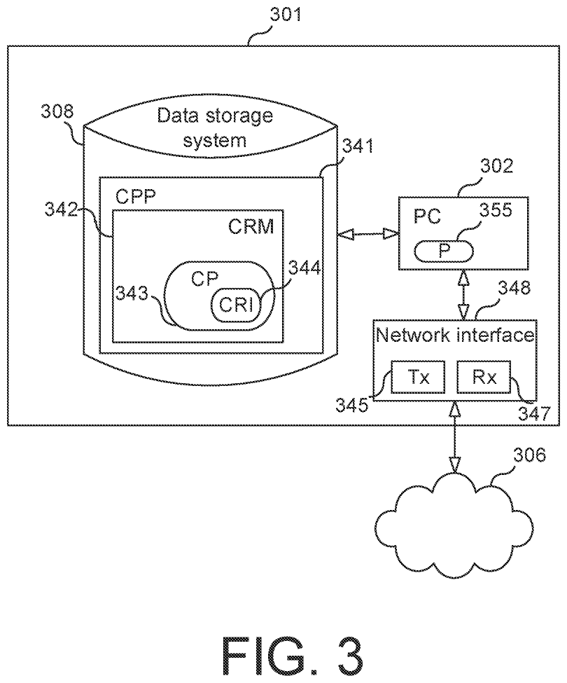

FIG. 3 is a block diagram of an apparatus 301, which may implement any of the access point 102, the storage system 104, the AUTH 106, the TSA system 108, the AI/ML 110 and the third party system(s) 112, according to some embodiments. In some embodiments, the apparatus 301 can be adapted to perform any of methods, processes, or steps disclosed herein. As shown in FIG. 3, the apparatus 301 may include processing circuitry (PC) 302, which may include one or more processors (P) 355 (e.g., one or more general purpose microprocessors and/or one or more other processors, such as an application specific integrated circuit (ASIC), field-programmable gate arrays (FPGAs), and the like), which processors 355 may be co-located in a single housing or in a single data center or may be geographically distributed.

In some embodiments, as shown in FIG. 3, the apparatus 301 may include one or more network interfaces 348 (which may be co-located or geographically distributed), and each network interface 348 may include a transmitter (Tx) 345 and a receiver (Rx) 347 for enabling apparatus 301 to transmit data to and receive data from other nodes connected to a network 306 (e.g., an Internet Protocol (IP) network) to which network interface 348 is connected. In some embodiments, the access point 102, the storage system 104, the AUTH 106, the TSA system 108, the AI/ML 110 and the third party system(s) 112 of the data securing and action tracking system 100 may be connected over the network 306. In some embodiments in which the apparatus 301 implements the access point 102, the network interface 348 may correspond to the network interface 120 of the access point 102. In some embodiments, although not shown in FIG. 3, the apparatus 301 may include a user interface (e.g., the user interface 118 of the access point 102).

In some embodiments, as shown in FIG. 3, the apparatus 301 may include one or more storage units (a.k.a., “data storage systems”) 308 which may be co-located or geographically distributed and which may include one or more non-volatile storage devices and/or one or more volatile storage devices. In some embodiments where the PC 302 includes a programmable processor, the one or more storage units may include a computer program product (CPP) 341. In some embodiments, the CPP 341 may include a computer readable medium (CRM) 342 storing a computer program (CP) 343 comprising computer readable instructions (CRI) 344. In some embodiments, the CRM 342 may be a non-transitory computer readable medium, such as, magnetic media (e.g., a hard disk), optical media, memory devices (e.g., random access memory, flash memory), and the like. In some embodiments, the CRI 344 of the computer program 343 is adapted such that when executed by the PC 302, the CRI 341 may cause apparatus 301 to perform steps described herein (e.g., steps described herein with reference to the flow charts). In other embodiments, the apparatus 301 may be adapted to perform steps described herein without the need for code. That is, for example, the PC 302 may consist merely of one or more ASICs. Hence, the features of the embodiments described herein may be implemented in hardware and/or software.

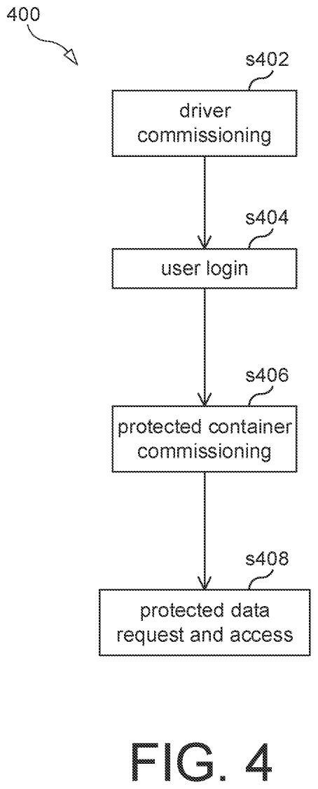

FIG. 4 is a flow chart illustrating a process 400 according to some non-limiting embodiments of the invention. In some embodiments, the data securing and action tracking system 100 (e.g., one or more access points 102, a storage system 104, an AUTH 106, a TSA system 108, an AI/ML system 110, and/or one or more third party systems 112) may perform one or more steps of the process 400.

In some embodiments, as shown in FIG. 4, the process 400 may include a step 402 in which the data securing and action tracking system 100 commissions or activates a driver 116 of an access point 102. In some embodiments, the process 400 may include a login step 404 in which the data securing and action tracking system 100 receives a user access request from a user of an access point 102 and approves or denies access for the user. In some embodiments, the process 400 may include a step 406 in which the system 100 commissions a new protected container 114. In some embodiments, the process 400 may include a step 408 in which the system 100 receives a protected data request from the user, approves or denies access to the protected data, and provides the user with access to protected data.

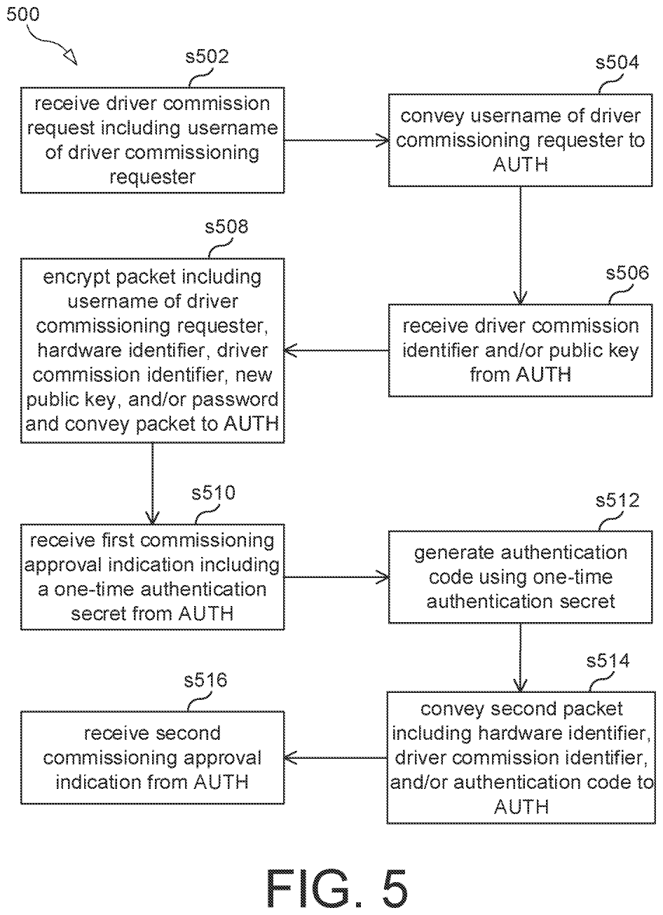

FIG. 5 is a flow chart illustrating a driver commissioning process 500 according to some non-limiting embodiments of the invention. In some embodiments, an access point 102 (e.g. a driver 116 of the access point 102) may perform one or more steps of the process 500. In some embodiments, one or more steps of the process 500 may be performed in the driver commissioning step 402 of the process 400 shown in FIG. 4.

In some embodiments, as shown in FIG. 5, the driver commissioning process 500 may include a step 502 in which a driver 116 of an access point 102 receives a driver commission request. In some embodiments, the driver commission request may include a username of a driver commissioning requester. In some embodiments, the driver commissioning requester may be, for example and without limitation, a user or an information technology (IT) professional that is setting up an access point 102 for use by one or more users. In some embodiments, the driver 116 may receive the commission request via the user interface 118 or via the network interface 120 of the access point 102.

In some embodiments, as shown in FIG. 5, the driver commissioning process 500 may include a step 504 in which the driver 116, in response to receiving the driver commission request in step 502, conveys the username of the driver commissioning requester to an authentication system (AUTH) 106 (e.g., via the network interface 120 over a secure connection). In some embodiments, the driver 116 may convey the username in a packet.

In some embodiments, as shown in FIG. 5, the driver commissioning process 500 may include a step 506 in which the driver 116 receives a driver commission identifier conveyed by the AUTH 106 (e.g., via the network interface 120 over the secure connection). In some embodiments, in the step 506, the driver 116 may receive a public key conveyed by the AUTH 106. In some embodiments, the public key may be received with the driver commission identifier. In some embodiments, the public key may be unique to the driver commission identifier.

In some embodiments, the driver 116 may receive the driver commission identifier in step 506 if the AUTH 106 determines that the username of the driver commissioning requester is valid. However, if the AUTH 106 determines that the username of the driver commissioning requester is invalid, the driver 116 may instead receive a commissioning denial indication in step 506. In some embodiments, if the driver 116 receives a commissioning denial indication in step 506, the driver 116 is not commissioned on the access point 102. In some embodiments, if the driver 116 receives a commissioning denial indication in step 506, the driver 116 of the access point 102 may indicate to the driver commissioning requester that the driver commission request was denied and/or that the username of the driver commissioning requester is invalid (e.g., via the user interface 118 or the network interface 120 of the access point 102).

In some embodiments, as shown in FIG. 5, the driver commissioning process 500 may include a step 508 in which the driver 116 encrypts a packet using the public key received in step 506 and conveys the encrypted packet to the AUTH 106 (e.g., via the network interface 120 over the secure connection). In some embodiments, the process 500 may proceed from step 506 to step 508 if the driver 116 receives a driver commission identifier in step 506. In some embodiments, the packet encrypted and conveyed in step 508 may include the username of the commission requester (received in step 502), a hardware identifier that uniquely identifies the access point 102 (e.g., a computer system), and/or the driver commission identifier (received in step 506). In some embodiments, the hardware identifier may be the same as the driver identification.

In some embodiments, the step 508 may include creating a new public key and a new private key for the driver 116. In some embodiments, the new public key and new private key may be unique to the current instance of the driver 116. In some embodiments, the packet conveyed in the step 508 may include the new public key. In some embodiments, the step 508 may include creating the hardware identifier that uniquely identifies the access point 102 on which the driver 116 is being commissioned.

In some embodiments, as shown in FIG. 5, the driver commissioning process 500 may include a step 510 in which the driver 116 receives a first commissioning approval indication or a commissioning denial indication conveyed by the AUTH 106. In some embodiments, the driver 116 may receive the approval or denial via the network interface 120 over the secure connection. In some embodiments, if the driver 116 receives a commissioning denial indication in step 510, the driver 116 is not commissioned on the access point 102. In some embodiments, if the driver 116 receives a commissioning denial indication in step 510, the driver 116 of the access point 102 may indicate to the driver commissioning requester that the commission request was denied (e.g., via the user interface 118 or the network interface 120 of the access point 102). In some embodiments, if a first commissioning approval indication is received in step 510, the first commissioning approval indication may include a one-time authentication secret.

In some embodiments, as shown in FIG. 5, the driver commissioning process 500 may include a step 512 in which the driver 116 uses the one-time authentication secret received in step 514 to generate an authentication code.

In some embodiments, as shown in FIG. 5, the driver commissioning process 500 may include a step 514 in which the driver 116 conveys a second packet to the AUTH 106 (e.g., via the network interface 120 over the secure connection). In some embodiments, the second packet may include the hardware identifier created in step 508, the driver commission identifier received in step 506, and/or the authentication code created in step 512. In some embodiments, the step 514 may include the driver 116 encrypting the second packet (e.g., using the public key received in step 506) before conveying the second packet.

In some embodiments, as shown in FIG. 5, the driver commissioning process 500 may include a step 516 in which the driver 116 receives a second commissioning approval indication or a commissioning denial indication conveyed by the AUTH 106. In some embodiments, the driver 116 may receive the approval or denial via the network interface 120 over the secure connection. In some embodiments, if the driver 116 receives a commissioning denial indication in step 516, the driver 116 is not commissioned on the access point 102. In some embodiments, if the driver 116 receives a commissioning denial indication in step 516, the driver 116 of the access point 102 may indicate to the driver commissioning requester that the commission request was denied (e.g., via the user interface 118 or the network interface 120 of the access point 102). In some embodiments, if a second commissioning approval indication is received in step 516, the driver 116 is commissioned on the access point 102, and a user of the access point 102 may use the driver 116 to login, commission one or more protected containers 114, and/or to request data in one or more protected containers 114. In some embodiments, if the driver 116 receives a commissioning approval indication in step 516, the driver 116 of the access point 102 may indicate to the driver commissioning requester that the commission request was approved (e.g., via the user interface 118 or the network interface 120 of the access point 102).

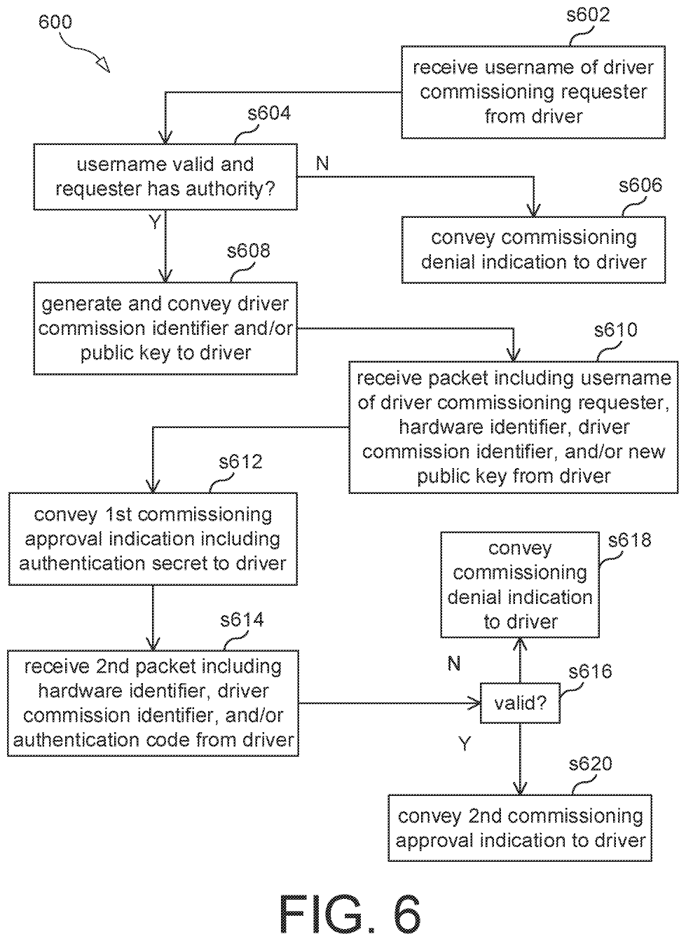

FIG. 6 is a flow chart illustrating a driver commissioning process 600 according to some non-limiting embodiments of the invention. In some embodiments, the authentication system (AUTH) 106 may perform one or more steps of the process 600. In some embodiments, one or more steps of the process 600 may be performed in the driver commissioning step 402 of the process 400 shown in FIG. 4.

In some embodiments, as shown in FIG. 6, the process 600 may include a step 602 in which the AUTH 106 receives a username of a driver commissioning requester from a driver 116 of an access point 102 (e.g., a computer system). In some embodiments, the AUTH 106 may receive the username via a network interface of the AUTH 106 over a secure connection with the driver 116 of the access point 102. In some embodiments, the AUTH 106 may receive a packet containing the username of the driver commissioning requester.

In some embodiments, as shown in FIG. 6, the process 600 may include a step 604 in which the AUTH 106 determines whether the username of the driver commissioning requester is valid. In some embodiments, determining that the username of the driver commissioning requester is valid may include comparing the username of the driver commissioning requester to a list of valid usernames and/or determining the username of the driver commissioning requester to be associated with the access point 102 on which a driver commission request is being made.

In some embodiments, the step 604 may include the AUTH 106 determining whether the driver commission requester has authority to commission the driver 116. In some embodiments, determining whether the driver commission requester has authority to commission the driver 116 may include comparing the username of the driver commission requester to a list of usernames having authority to commission drivers. In some embodiments, determining whether the driver commission requester has authority to commission the driver 116 may additionally or alternatively include determining whether the driver commission requester has the required permissions to be able to commission drivers. In some embodiments, the permission of the driver commission requester may be set by a system administrator.

In some embodiments, as shown in FIG. 6, the process 600 may include a step 606 in which the AUTH 106 conveys a commissioning denial indication to the driver 116 of the access point 102. In some embodiments, the process 600 may proceed from step 604 to step 606 if the AUTH 106 determines the username of the driver commissioning requester to be invalid in step 604 and/or determines that the driver commission requester does not have authority to commission the driver 116 in step 604. In some embodiments, the AUTH 106 may convey the commissioning denial indication via the network interface of the AUTH 106 over the secure connection with the driver 116.

In some embodiments, as shown in FIG. 6, the process 600 may include a step 608 in which the AUTH 106 generates a driver commission identifier and conveys the driver commission identifier to the driver 116 of the access point 102 (e.g., via the network interface of the AUTH 106 over the secure connection with the driver 116). In some embodiments, the process 600 may proceed from step 604 to step 608 if the AUTH 106 determines the username of the driver commissioning requester to be valid and determines that the driver commission requester does has authority to commission the driver 116 in step 604.

In some embodiments, the step 608 may include the AUTH 106 generating a public key and private key pair and conveying the public key to the driver 116 of the access point 102. In some embodiments, the public key may be unique to the driver commission identifier. In some embodiments, the AUTH 106 may convey the public key with the driver commission identifier. In some embodiments, the AUTH 106 may convey the driver commission identifier and the public key via the network interface of the AUTH 106 over the secure connection.

In some embodiments, as shown in FIG. 6, the process 600 may include a step 610 in which the AUTH 106 receives an encrypted packet conveyed by the driver 116 of the access point 102. In some embodiments, the AUTH 106 may receive the encrypted packet via the network interface of the AUTH 106 over the secure connection.

In some embodiments, the driver 116 may have encrypted the packet using the public key generated by the AUTH 106 and conveyed to the driver 116 in step 608. In some embodiments, the step 610 may include the AUTH 106 decrypting the received packet using the private key generated in step 608. In some embodiments, the packet may include the username of the driver commission requester, a hardware identifier that uniquely identifies the access point 102, the driver commission identifier, and/or a public key unique to the current instance of the driver 116 of the access point 102.

In some embodiments, as shown in FIG. 6, the process 600 may include a step 612 in which the AUTH 106 conveys a first commissioning approval indication to the driver 116 of the access point 102. In some embodiments, the first commissioning approval indication may include a one-time authentication secret, and step 612 may include creating the one-time authentication secret. In some embodiments, the AUTH 106 may convey the first commissioning approval indication via the network interface of the AUTH 106 over the secure connection.

In some embodiments, as shown in FIG. 6, the process 600 may include a step 614 in which the AUTH 106 receives a packet conveyed by the driver 116 of the access point 102 (e.g., via the network interface of the AUTH 106 over the secure connection with the driver 116). In some embodiments, the packet may include an authentication code generated using the one-time authentication secret conveyed in step 612, the hardware identifier, and the driver commission identifier. In some embodiments, the driver 116 may have encrypted the packet using the public key generated by the AUTH 106 and conveyed to the driver 116 in step 608. In some embodiments, the step 614 may include the AUTH 106 decrypting the received packet using the private key generated in step 608.

In some embodiments, as shown in FIG. 6, the process 600 may include a step 616 in which the AUTH 106 determines whether the authentication code, the hardware identifier, and/or the driver commission identifier are valid. In some embodiments, the step 616 may include the AUTH 106 determining whether the authentication code matches what is expected for the driver commission identifier (e.g., based on the one-time authentication secret created and conveyed in step 612). In some embodiments, the step 616 may additionally or alternatively include the AUTH 106 determining whether the hardware identifier matches what is expected for the driver commission identifier.

In some embodiments, as shown in FIG. 6, the process 600 may include a step 618 in which the AUTH 106 conveys a commissioning denial indication to the driver 116 of the access point 102. In some embodiments, the process 600 may proceed from step 616 to step 618 if any portion of the validation of step 616 fails. In some embodiments, the AUTH 106 may convey the commissioning denial indication via the network interface of the AUTH 106 over the secure connection.

In some embodiments, as shown in FIG. 6, the process 600 may include a step 620 in which the AUTH 106 conveys a second commissioning approval indication to the driver 116 of the access point 102. In some embodiments, the process 600 may proceed from step 616 to step 620 if the validation of step 616 is successful. In some embodiments, the second commissioning approval indication may indicate that the driver 116 is commissioned on the access point 102, and a user of the access point 102 may use the driver 116 to login, commission one or more protected containers 114, and/or to request data in one or more protected containers 114. In some embodiments, the AUTH 106 may convey the second commissioning approval indication via the network interface of the AUTH 106 over the secure connection.

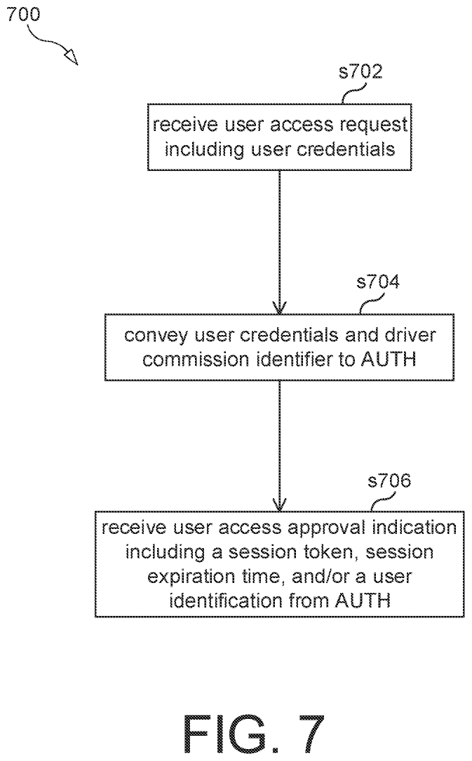

FIG. 7 is a flow chart illustrating a login process 700 according to some non-limiting embodiments of the invention. In some embodiments, an access point 102 (e.g. a driver 116 of the access point 102) may perform one or more steps of the process 700. In some embodiments, one or more steps of the login process 700 may be performed in the login step 404 of the process 400 shown in FIG. 4.

In some embodiments, as shown in FIG. 7, the process 700 may include a step 702 in which a driver 116 of an access point 102 receives a user access request from a user. In some embodiments, the user may be the same person as the driver commissioning requester. However, this is not requires, and, in some alternative embodiments, the user may be a different person than the driver commissioning requester (e.g., the driver commissioning requester may be an IT professional who setup the access point 102 for use by any user having the proper credentials). In some embodiments, the driver 116 may receive the user access request via the user interface 118 or via the network interface 120 of the access point 102. In some embodiments, the user access request may include user credentials. In some embodiments, the user credentials may include a username, a password, and/or an authentication code. In some embodiments, the authentication code may be a multifactor authentication code.

In some embodiments, as shown in FIG. 7, the process 700 may include a step 704 in which the driver 116, in response to receiving the user access request, conveys the username (received in step 702) and the driver commission identifier (received in step 402 of the process 400 of FIG. 4 and/or step 506 of the driver commissioning process 500 of FIG. 5) to the AUTH 106 (e.g., via the network interface 120 over a secure connection). In some embodiments, in step 704, the driver 116 may convey the user credentials (including the username, password, and/or authentication code) to the AUTH 106. In some embodiments, the step 704 may further include creating a password hash using the user credentials of the user access request and conveying the password hash to the AUTH 106 (e.g., via the network interface 120 over a secure connection). In some embodiments, the driver 116 may convey the password hash with the username and the driver commission identifier. In some embodiments, the driver 116 may encrypt the user credentials to create the password hash.

In some embodiments, as shown in FIG. 7, the process 700 may include a step 706 in which the driver 116 receives either a user access approval indication or a user access denial indication conveyed by the AUTH 106. In some embodiments, the driver 116 may receive the approval or denial via the network interface 120 over the secure connection. In some embodiments, if the driver 116 receives a user access denial indication in step 706, the user is not allowed access to the driver 116 and, therefore, cannot use the driver 116 to commission one or more protected containers 114 and/or to request data in one or more protected containers 114. In some embodiments, if the driver 116 receives a user access denial indication in step 706, the driver 116 of the access point 102 may indicate to the user that the user access request was denied (e.g., via the user interface 118 or the network interface 120 of the access point 102).

In some embodiments, if the driver 116 receives a user access approval indication in step 706, the user access approval indication may include a session token, a session expiration time, and/or an identification of the user associated with the username. In some embodiments, the session token may allow the user access to the driver 116. In some embodiments, access to the driver 116 may enable the user to use the driver 116 to commission one or more protected containers 114 and/or to request data in one or more protected containers 114. In some embodiments, the identification of the user may be a unique identification (e.g., a universally unique identification (UUID) or a globally unique identification (GUID)). In some embodiments, if the driver 116 receives a user access approval indication in step 706, the driver 116 of the access point 102 may indicate to the user that the user access request was approval (e.g., via the user interface 118 or the network interface 120 of the access point 102).

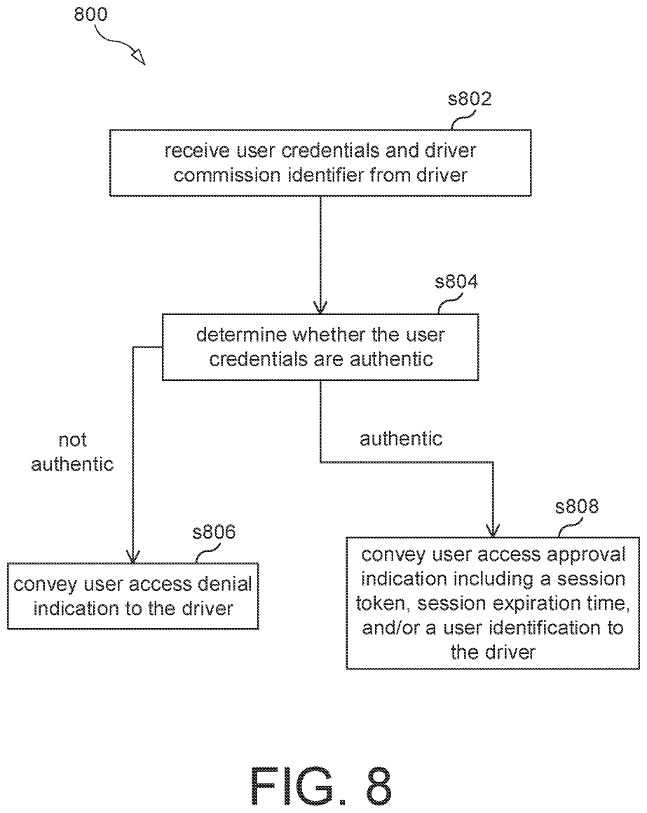

FIG. 8 is a flow chart illustrating a login process 800 according to some non-limiting embodiments of the invention. In some embodiments, the authentication system (AUTH) 106 may perform one or more steps of the login process 800. In some embodiments, one or more steps of the process 800 may be performed in the login step 404 of the process 400 shown in FIG. 4.

In some embodiments, as shown in FIG. 8, the process 800 may include a step 802 in which the AUTH 106 receives a user access request conveyed by a driver 116 of an access point 102 (e.g., a computer system). In some embodiments, the user access request may be received in an encrypted packet. In some embodiments, the step 802 may include decrypting the encrypted packet. In some embodiments, the user access request may include user credentials of a user access requester, a driver commission identifier (e.g., the driver commission identifier generated and conveyed in step 608 of the commissioning process 600), and/or a password hash. In some embodiments, the user credentials may include a username of the user access requester, a password, and/or an authentication code (e.g., a multifactor authentication code). In some embodiments, the authentication code may be a one-time authentication code.

In some embodiments, as shown in FIG. 8, the process 800 may include a step 804 in which the AUTH 106 determines whether the user credentials of the user access requester are authentic. In some embodiments, determining whether the user credentials of the user access requester are authentic may include verifying the password and/or the authentication code. In some embodiments, determining whether the user credentials of the user access requester are authentic may additionally or alternatively include creating a password hash using the user credentials of the user access request and determining that the created password hash matches the password hash of the user access request received in step 802.

In some embodiments, as shown in FIG. 8, the process 800 may include a step 806 in which the AUTH 106 conveys a user access denial indication to the driver 116 of the access point 102. In some embodiments, the process 800 may proceed from step 804 to step 806 if the AUTH 106 determines the user credentials of the user access requester to be not authentic in step 904. In some embodiments, the AUTH 106 may convey the user access denial indication via the network interface of the AUTH 106 over the secure connection.

In some embodiments, as shown in FIG. 8, the process 800 may include a step 808 in which the AUTH 106 conveys a user access approval indication to the driver 116 of the access point 102. In some embodiments, the process 800 may proceed from step 804 to step 806 if the AUTH 106 determines the user credentials of the user access requester to be authentic in step 804. In some embodiments, the AUTH 106 may convey the user access approval indication via the network interface of the AUTH 106 over the secure connection.

In some embodiments, the user access approval indication conveyed in step 808 may include a session token, and step 808 may include creating the session token. In some embodiments, the user access approval indication may further include a session expiration time, and the step 808 may include creating the session expiration time. In some embodiments, the user access approval indication may additionally include an identification of the user access requester. In some embodiments, the identification of the user access requester may be a unique identification (e.g., a universally unique identification (UUID) or a globally unique identification (GUID)).

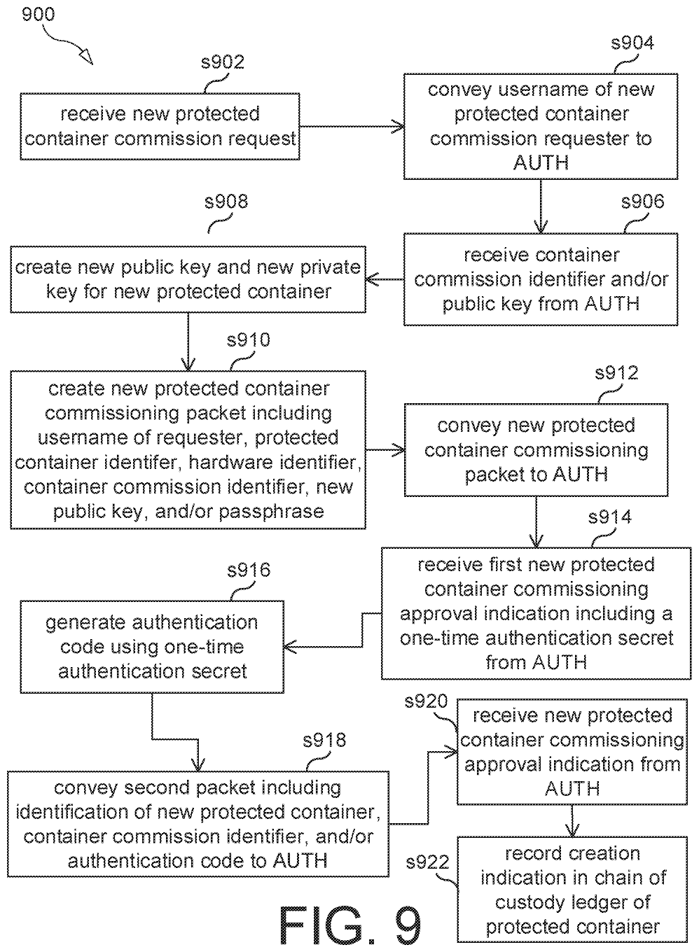

FIG. 9 is a flow chart illustrating a protected container commissioning process 900 according to some non-limiting embodiments of the invention. In some embodiments, an access point 102 (e.g. a driver 116 of the access point 102) may perform one or more steps of the process 900. In some embodiments, one or more steps of the protected container commissioning process 900 may be performed in the protected container commissioning step 406 of the process 400 shown in FIG. 4.

In some embodiments, as shown in FIG. 9, a protected container commissioning process 900 may include a step 902 in which a driver 116 of an access point 102 receives a new protected container commission request from a new protected container commissioning requester. In some embodiments, the new protected container commissioning requester may be a user that has been allowed access to the driver 116 using the login process 700 of FIG. 7. In some embodiments, the new protected container commission request may include a username of the protected container commissioning requester. In some embodiments, the new protected container commission request may additionally or alternatively include a security level, permission level, and/or data privacy/compliance standards (e.g., one or more standard acronyms/names such as HIPPA, HITECH, SOX, GDPR, etc.) for the new protected container. In some embodiments, the driver 116 may receive the new protected container commission request via the user interface 118 or via the network interface 120 of the access point 102.

In some embodiments, the new protected container commission request received from the new protected container commissioning requester in step 902 may optionally include a passphrase. In some embodiments, the passphrase may be all or part of an encryption key for the new protected container 114. In some embodiments, the step 902 may include the driver 116 determining whether the new protected container commission request includes a passphrase. In some embodiments, the step 902 may include the driver 116 creating a passphrase if the driver 116 determines that the received new protected container commission request does not include a passphrase.

In some embodiments, as shown in FIG. 9, the protected container commissioning process 900 may include a step 904 in which the driver 116 of the access point 102, in response to receiving the new protected container commission request, conveys the username of the new protected container commissioning requester to the authentication system (AUTH) 106 (e.g., via the network interface 120 over a secure connection).

In some embodiments, as shown in FIG. 9, the protected container commissioning process 900 may include a step 906 in which the driver 116 receives a container commission identifier conveyed by the AUTH 106. In some embodiments, in step 906, the driver 116 may additionally receive a public key from the AUTH 106, and the public key may be unique to the container commission identifier. In some embodiments, the driver 116 may receive the container commission identifier via the network interface 120 over the secure connection. In some embodiments, the container commission identifier may be associated with commissioning the new protected container 114.

In some embodiments, in step 906, the driver 116 may receive a container commission public key conveyed by the AUTH 106. In some embodiments, the container commission public key may be received with the container commission identifier. In some embodiments, the container commission public key may be unique to the container commission identifier.

In some embodiments, as shown in FIG. 9, the protected container commissioning process 900 may include a step 908 in which the driver 116 creates a new public key and a new private key for the new protected container 114.

In some embodiments, as shown in FIG. 9, the protected container commissioning process 900 may include a step 910 in which the driver 116 creates a new protected container commissioning packet. In some embodiments, the new protected container commissioning packet may include the username of the new protected container commissioning requester (received in step 902), the hardware identifier that uniquely identifies the access point 102, an identification for the new protected container 114, the container commission identifier (received in step 906), the new public key for the new protected container 114 (created in step 908), and/or the passphrase (received or created in step 902). In some embodiments, creating the new protected container commissioning packet may include encrypting one or more portions of the new protected container commissioning packet (e.g., encrypting new public key for the new protected container 114 and/or the passphrase). In some embodiments, other portions of the new protected container commissioning packet (e.g., the username of the new protected container commissioning requester, the hardware identifier, the identification for the new protected container 114, and/or the container commission identifier) may not be encrypted. In some embodiments, encrypting the one or more portions of the new protected container commissioning packet may include using the container commission public key (received in step 906) or the public key received in step 506, which may be unique to the driver commission identifier, to encrypt the new protected container commissioning packet. In some embodiments, the new protected container commissioning packet may additionally or alternatively include the security level, permission level, and/or data privacy/compliance standards for the new protected container 114.

In some embodiments, step 910 may include the driver 116 creating the identification for the new protected container 114. In some embodiments, the identification for the new protected container 114 may uniquely identify the new protected container 114. In some embodiments, the identification for the new protected container 114 may be a universally unique identification (UUID) or a globally unique identification (GUID)).

In some embodiments, as shown in FIG. 9, the protected container commissioning process 900 may include a step 912 in which the driver 116 conveys the encrypted new protected container commissioning packet to the AUTH 106 (e.g., via the network interface 120 over the secure connection).

In some embodiments, as shown in FIG. 9, the protected container commissioning process 900 may include a step 914 in which the driver 116 receives a first new protected container approval indication or a new protected container denial indication conveyed by the AUTH 106. In some embodiments, the driver 116 may receive the approval or denial indication via the network interface 120 over the secure connection. In some embodiments, if the driver 116 receives a new protected container denial indication in step 914, the new protected container 114 is not commissioned, and the new protected container commissioning requester would need to make another new protected container commission request to start another protected container commissioning process 900. In some embodiments, if the driver 116 receives a new protected container denial indication in step 914, the driver 116 of the access point 102 may indicate to the new protected container commissioning requester that the new protected container commission request was denied (e.g., via the user interface 118 or the network interface 120 of the access point 102). In some embodiments, if the driver 116 receives a first new protected container approval indication in step 914, the new protected container approval indication may include a one-time authentication secret.

In some embodiments, as shown in FIG. 9, the protected container commissioning process 900 may include a step 916 in which the driver 116 generates an authentication code using the one-time authentication secret.

In some embodiments, as shown in FIG. 9, the protected container commissioning process 900 may include a step 918 in which the driver 116 conveys a second new protected container commissioning packet to the AUTH 106 (e.g., via the network interface 120 over the secure connection). In some embodiments, the second new protected container commissioning packet may include the identification for the new protected container 114, the authentication code generated in step 916, and/or the container commission identifier received in step 906. In some embodiments, the step 916 may include the driver 116 encrypting the second new protected container commissioning packet (e.g., using the container commission public key received in step 906) before conveying the second new protected container commissioning packet.

In some embodiments, the identification for the new protected container 114 may be created and conveyed to the AUTH 106 in step 910. However, this is not required, and, in some alternative embodiments, step 918 may include the driver 116 creating the identification for the new protected container 114. In some embodiments, the identification for the new protected container 114 may uniquely identify the new protected container 114. In some embodiments, the identification for the new protected container 114 may be a universally unique identification (UUID) or a globally unique identification (GUID)).

In some embodiments, as shown in FIG. 9, the protected container commissioning process 900 may include a step 920 in which the driver 116 receives a second new protected container approval indication or a new protected container denial indication conveyed by the AUTH 106. In some embodiments, the driver 116 may receive the approval or denial indication via the network interface 120 over the secure connection. In some embodiments, if the driver 116 receives a new protected container denial indication in step 918, the new protected container 114 is not commissioned, and the new protected container commissioning requester would need to make another new protected container commission request to start another protected container commissioning process 900. In some embodiments, if the driver 116 receives a new protected container denial indication in step 918, the driver 116 of the access point 102 may indicate to the new protected container commissioning requester that the new protected container commission request was denied (e.g., via the user interface 118 or the network interface 120 of the access point 102).

In some embodiments, if a second new protected container approval indication is received in step 920, the driver 116 may create the new protected container 114 on the storage system 104. In some embodiments, if the driver 116 receives a second new protected container approval indication in step 920, the driver 116 of the access point 102 may indicate to the new protected container commissioning requester that the new protected container commission request was approved and successfully created (e.g., via the user interface 118 or the network interface 120 of the access point 102).

In some embodiments, as shown in FIG. 9, the protected container commissioning process 900 may include a step 922 in which the driver 116 of the access point 102 conveys a “created” message to the TSA 108. In some embodiments, the “created” message may include a packet and a hash of the packet. In some embodiments, the packet may include the container identification 212, the username of the new protected container commission requester, the security level of the new protected container 114, the permissions 214 of the new protected container 114 (e.g. User only, Group accessible, Department accessible, Company accessible, or Global), and/or data privacy/compliance standards (e.g., one or more standard acronyms/names such as HIPPA, HITECH, SOX, GDPR, etc.) of the new protected container 114. In some embodiments, the TSA 108 may record the packet and/or packet hash in a chain of custody ledger of the TSA 108. In some embodiments, in step 922, the driver 116 may receive from the TSA 108 a timestamp and signature and record the timestamp and signature in the ledger 216 of the new protected container 114. In some embodiments, the process 900 may proceed to step 922 from step 920 if the driver 116 receives a second new protected container approval indication in step 920.

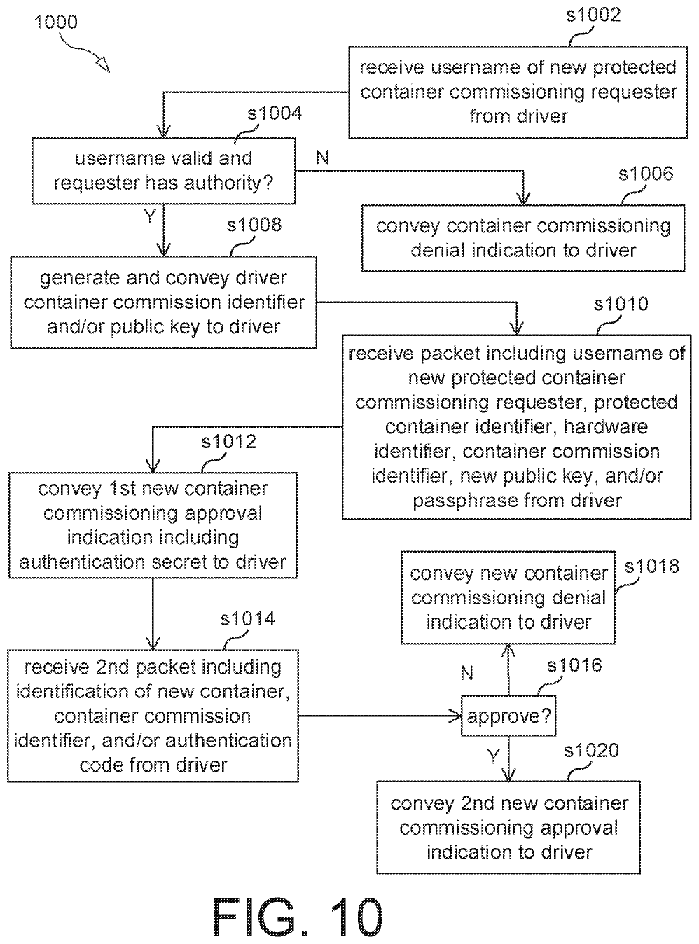

FIG. 10 is a flow chart illustrating a protected container commissioning process 1000 according to some non-limiting embodiments of the invention. In some embodiments, the authentication system (AUTH) 106 may perform one or more steps of the protected container commissioning process 1000. In some embodiments, one or more steps of the process 1000 may be performed in the protected container commissioning step 406 of the process 400 shown in FIG. 4.

In some embodiments, as shown in FIG. 10, a protected container commissioning process 1000 may include a step 1002 in which the AUTH 106 receives a username of a new protected container commissioning requester conveyed by the driver 116 of an access point 102 (e.g., a computer system).

In some embodiments, as shown in FIG. 10, the process 1000 may include a step 1004 in which the AUTH 106 determines whether the username of the new protected container commissioning requester is valid. In some embodiments, determining that the username of the new protected container commissioning requester is valid may include comparing the username of the new protected container commissioning requester to a list of valid usernames.

In some embodiments, the step 1004 may include the AUTH 106 determining whether the new protected container commissioning requester has authority to commission the new protected container. In some embodiments, determining whether the new protected container commissioning requester has authority to commission the new protected container may be based on access rights of the new protected container commissioning requester. In some embodiments, determining whether the new protected container commissioning requester has authority to commission the new protected container may include determining whether the new protected container commissioning requester has the required permissions to be able to commission new protected containers. In some embodiments, determining whether the new protected container commissioning requester has authority to commission the new protected container may include the AUTH 106 comparing access rights of the new protected container commissioning requester with the security level, permission level, and/or data privacy/compliance standards for the new protected container. In some embodiments, the access rights may define what a user (e.g., new protected container commissioning requester) can and cannot access in the system 100. In some embodiments, a system administrator may have assigned the access rights to the new protected container commissioning requester. In some embodiments, access rights may be modified by the AI/ML system 110.

In some embodiments, as shown in FIG. 10, the process 1000 may include a step 1006 in which the AUTH 106 conveys a container commissioning denial indication to the driver 116 of the access point 102. In some embodiments, the process 1000 may proceed from step 1004 to step 1006 if the AUTH 106 determines the username of the new protected container commissioning requester to be invalid in step 1004 and/or determines that the new protected container commissioning requester does not have authority to commission the new protected container in step 1004. In some embodiments, the AUTH 106 may convey the container commissioning denial indication via the network interface of the AUTH 106 over the secure connection with the driver 116.

In some embodiments, as shown in FIG. 10, the process 1000 may include a step 1008 in which the AUTH 106 generates a container commission identifier and conveys the container commission identifier to the driver 116 of the access point 102 (e.g., via a network interface of the AUTH 106 over a secure connection with the driver 116). In some embodiments, in step 1008, the AUTH 106 may additionally convey a public key that is unique to the container commission identifier. In some embodiments, the process 1000 may proceed from step 1004 to step 1008 if the AUTH 106 determines the username of the new protected container commissioning requester to be valid and determines that the new protected container commissioning requester has authority to commission the new protected container in step 1004.

In some embodiments, the step 1008 may include the AUTH 106 generating a container commission public key and private key pair and conveying the container commission public key to the driver 116 of the access point 102. In some embodiments, the container commission public key may be unique to the container commission identifier. In some embodiments, the AUTH 106 may convey the container commission public key with the container commission identifier. In some embodiments, the AUTH 106 may convey the container commission identifier and the container commission public key via the network interface of the AUTH 106 over the secure connection.

In some embodiments, as shown in FIG. 10, the process 1000 may include a step 1010 in which the AUTH 106 receives a new protected container commissioning packet conveyed by the driver 116 of the access point 102. In some embodiments, the new protected container commissioning packet may have been encrypted using the container commission public key generated and conveyed in step 1008. In some embodiments, the step 1010 may include the AUTH 106 decrypting the new protected container commissioning packet using the private key generated in step 1008. In some embodiments, the new protected container commissioning packet may include the username of the new protected container commissioning requester (received in step 1002), the hardware identifier that uniquely identifies the access point 102, the identification for the new protected container 114, the container commission identifier (generated and conveyed in step 1008), a new public key for the new protected container 114 (e.g., created by the driver 116 in step 908), and/or a passphrase (e.g., received or created by the driver 116 in step 902). In some embodiments, the passphrase may be all or part of an encryption key for the new protected container 114. In some embodiments, the new protected container commissioning packet may additionally or alternatively include the security level, permission level, and/or data privacy/compliance standards for the new protected container.

In some embodiments, one or more portions of the new protected container commissioning packet may have been encrypted (e.g., using the container commission public key generated and conveyed in step 1008 or the public key generated and conveyed in step 608). In some embodiments, the one or more encrypted portions of the new protected container commissioning packet may include the new public key for the new protected container 114 (e.g., created by the driver 116 in step 908) and/or the passphrase (e.g., received or created by the driver 116 in step 902). In some embodiments, the step 1010 may include the AUTH 106 decrypting the one or more encrypted portions of the new protected container commissioning packet (e.g., using the private key generated in step 1008 or the private key generated in step 608).

In some embodiments, as shown in FIG. 10, the process 1000 may include a step 1012 in which the AUTH 106 conveys a first new protected container approval indication to the driver 116 of the access point 102. In some embodiments, the first new protected container approval indication may include a one-time authentication secret. In some embodiments, the AUTH 106 may convey the first new protected container approval indication via the network interface of the AUTH 106 over the secure connection.

In some embodiments, as shown in FIG. 10, the process 1000 may include a step 1014 in which the AUTH 106 receives a second encrypted new protected container commissioning packet conveyed by the driver 116 of the access point 102. In some embodiments, the second new protected container commissioning packet may have been encrypted using the container commission public key generated and conveyed in step 1008. In some embodiments, the step 1014 may include the AUTH 106 decrypting the second new protected container commissioning packet using the private key generated in step 1008. In some embodiments, the new protected container commissioning packet may include an identification for the new protected container 114, an authentication code, and/or the container commission identifier (generated and conveyed in step 1008). In some embodiments, the identification for the new protected container 114 may uniquely identify the new protected container 114. In some embodiments, the identification for the new protected container 114 may be a universally unique identification (UUID) or a globally unique identification (GUID)). The driver 116 may have generated the authentication code using the one-time authentication secret.

In some embodiments, as shown in FIG. 10, the process 1000 may include a step 1016 in which the AUTH 106 determines whether to approve commissioning of the new protected container 114. In some embodiments, determining whether to approve commissioning of the new protected container 114 may include determining that the session token of the received second new protected container commissioning packet is active. In some embodiments, determining whether to approve commissioning of the new protected container 114 may additionally or alternatively include validating that the authentication code received in step 1014 matches what is expected.

In some embodiments, as shown in FIG. 10, the process 1000 may include a step 1018 in which the AUTH 106 conveys a new protected container denial indication to the driver 116 of the access point 102. In some embodiments, the process 1000 may proceed from step 1016 to step 1018 if the AUTH 106 determines to deny commissioning of the new protected container in step 1016. In some embodiments, the AUTH 106 may convey the new protected container denial indication via the network interface of the AUTH 106 over the secure connection.

In some embodiments, as shown in FIG. 10, the process 1000 may include a step 1020 in which the AUTH 106 conveys a second new protected container approval indication to the driver 116 of the access point 102. In some embodiments, the process 1000 may proceed from step 1016 to step 1020 if the AUTH 106 determines to approve commissioning of the new protected container in step 1016. In some embodiments, the AUTH 106 may convey the second new protected container approval indication via the network interface of the AUTH 106 over the secure connection.

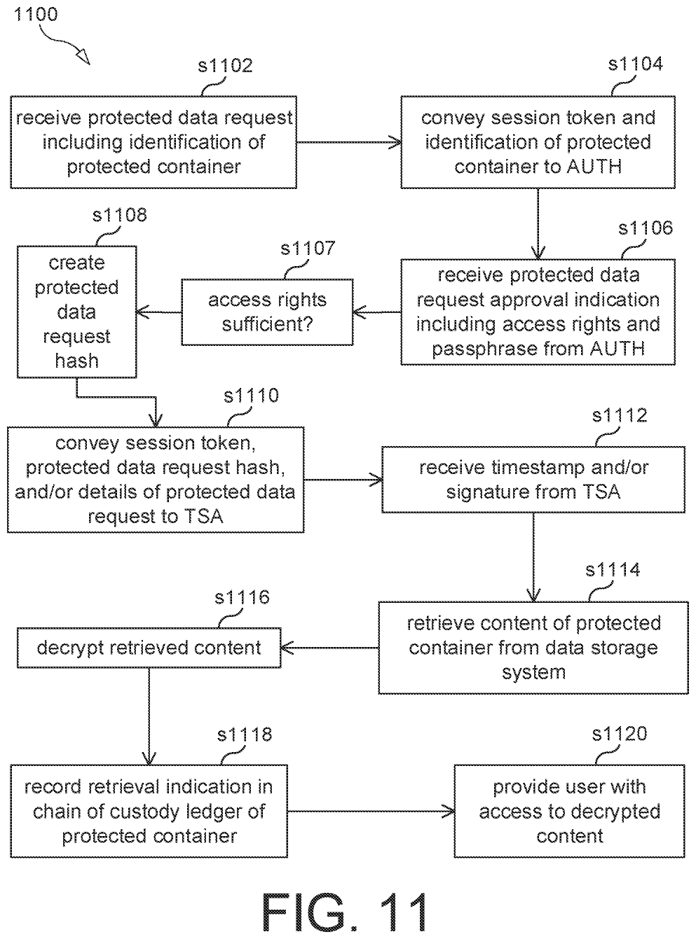

FIG. 11 is a flow chart illustrating a protected data request and access process 1100 according to some non-limiting embodiments of the invention. In some embodiments, an access point 102 (e.g. a driver 116 of the access point 102) may perform one or more steps of the process 1100. In some embodiments, one or more steps of the process 900 may be performed in the protected data request and access step 408 of the process 400 shown in FIG. 4.

In some embodiments, as shown in FIG. 11, the process 1100 may include a step 1102 in which the driver 116 of the access point 102 receives a protected data request from the user. In some embodiments, the driver 116 may receive the protected data request via the user interface 118 or via the network interface 120 of the access point 102. In some embodiments, the protected data request may relate to content (e.g., raw data) of a protected container 114. In some embodiments, the protected data request may relate to content of one or more of the sub-containers 204 of the protected container 114. In some embodiments, the protected data request may include an identification of the protected container 114. In some embodiments, the identification of the protected container 114 may be a unique identification (e.g., a universally unique identification (UUID) or a globally unique identification (GUID)). In some embodiments, the user making the protected data request relating to the protected container 114 may be the same user as the new protected container commissioning requester that commissioned the protected container 114 or a different user. That is, the user requested protected content of a protected container 114 may be the same user that commissioned the protected container 114 (e.g., in step 406 of FIG. 4 and/or process 900 of FIG. 9) or a different user. In some embodiments, the protected container 114 to which the protected data request relates may have been commissioned by the same driver 116 of the same access point 102 that received the protected data request, or the protected container 114 to which the protected data request relates may have been commissioned by a different driver 116 of a different access point 102 of the data securing and action tracking system 100.

In some embodiments, as shown in FIG. 11, the process 1100 may include a step 1104 in which the driver 116 conveys the session token and the identification of the protected container 114 to the AUTH 106 (e.g., via the network interface 120 over a secure connection). In some embodiments, in step 1104, the driver 116 may also convey the one-time authentication code for the driver 116 (e.g., generated in step 516 of the driver commissioning process 506).

In some embodiments, as shown in FIG. 11, the process 1100 may include a step 1106 in which the driver 116 receives a protected data request approval indication or a protected data request denial indication conveyed by the AUTH 106. In some embodiments, if the driver 116 receives a protected data request denial indication in step 1106, the user is not allowed access to the requested protected data. In some embodiments, if the driver 116 receives a protected data request denial indication in step 1106, the driver 116 of the access point 102 may indicate to the user that the protected data request was denied (e.g., via the user interface 118 or the network interface 120 of the access point 102).

In some embodiments, if the driver 116 receives a protected data request approval indication in step 1106, the protected data request approval indication may include access rights and/or permissions for the user with respect to the protected container 114 and/or a passphrase for the protected container 114 (e.g., the passphrase received or created in step 902 of the protected container commissioning process 900). In some embodiments, the access rights and/or permissions may specify whether the user is able to read, write, and/or delete the data of the protected container 114. In some embodiments, the access rights and/or permissions may have been determined by the AUTH 106 using the user's defined permissions, the protected container's security level, protected container permissions level, and/or data privacy/compliance standards. In some embodiments, the user's defined permission may have been assigned by a system administrator (and may have been modified by the AI/ML system 110). In some embodiments, the passphrase may correspond to all or part of the encryption key for the protected data.

In some embodiments, as shown in FIG. 11, the process 1100 may include a step 1107 in which the driver 116 uses the received access rights to determine whether the user is able to perform an action (e.g., read a file stored the protected container 114, overwrite a file stored in the protected container 114, write a new file to the protected container 114, delete a file of the protected container 114, delete the protected container 114, etc.) requested by the protected data request. In some embodiments, if the driver 116 determines that the user does not have the access right to perform the requested action, the driver 116 denies access to the protected container 114 for the requested action. In some embodiments, if the driver 116 denies access in step 1107, the driver 116 may indicate to the user that the protected data request was denied (e.g., via the user interface 118 or the network interface 120 of the access point 102). In some embodiments, if the driver 116 determines that the user does have the access right to perform the requested action, the process 1100 may proceed from the step 1107 to a step 1108.

In some embodiments, as shown in FIG. 11, the process 1100 may include a step 1108 in which the driver 116 creates a protected data request hash of one or more details of the protected data request. In some embodiments, the details of the protected data request may include a request type (e.g., read or write), the identification of the protected container 114 received in the protected data request, an identification of the user who has requested the protected data (e.g., the identification of the user in the user access approval indication received in step 706 of the login process 700), a one-time authentication code, the session token received by the driver 116 in step 706 of the login process 700, and/or the driver commission identifier received by the driver 116 in step 506 of the driver commissioning process 500.

In some embodiments, as shown in FIG. 11, the process 1100 may include a step 1110 in which the driver 116 conveys the session token (received by the driver 116 in step 706 of the login process 700), the protected data request hash (created in step 1108), and the details of the protected data request to a time stamp authority (TSA) system 108 (e.g., via the network interface 120 over a secure connection with the TSA system 108).

In some embodiments, as shown in FIG. 11, the process 1100 may include a step 1112 in which the driver 116 receives a timestamp and/or a signature conveyed by the TSA system 108. In some embodiments, the driver 116 may receive the timestamp and/or the signature via the network interface 120 of the access point 102. In some embodiments, the step 1112 may include the driver 1112 storing the timestamp and signature (e.g., in a data storage system of the access point 102). In some embodiments, the driver 116 receives the timestamp and/or a signature in step 1112 if the TSA system 108 determines that the session token conveyed in step 1110 is valid. In some embodiments, if the TSA system 108 instead determines that the session token is invalid, the driver 116 would instead receive an error indication in step 1112 and deny the protected data request.

In some embodiments, as shown in FIG. 11, the process 1100 may include a step 1114 in which the driver 116 retrieves the content of the protected container 114 to which the protected data request relates from the data storage system 104. In some embodiments, the retrieved content may include raw data 206 and/or metadata 210 of the protected container 114.

In some embodiments, as shown in FIG. 11, the process 1100 may include a step 1116 in which the driver 116 decrypts the retrieved content. In some embodiments, the driver 116 may use the passphrase of the protected container 114 (received in step 1106) to decrypt the retrieved content. In some embodiments, the driver 116 may use the encryption key(s) generated for the protected container 114 to decrypt the retrieved content. In some embodiments, the encryption key(s) may be generated when the protected container 114 is commissioned. In some embodiments, the encryption key(s) may be based (in all or part) on the passphrase included in the protected data request approval indication received in step 1106.

In some embodiments, as shown in FIG. 11, the process 1100 may include a step 1118 in which the driver 116 records a retrieval indication in the chain of custody ledger 216 of the protected container 114 from which the content is retrieved. In some embodiments, the retrieval indication may include the timestamp and the signature received from the TSA system 108 in step 1112. In some embodiments, the retrieval indication may additionally include identification of the user who has requested the protected data (e.g., the identification of the user in the user access approval indication received in step 706 of the login process 700), the details of the protected data request, and/or the hash of the one or more details of the protected data request (created by the driver 116 in step 1108).

In some embodiments, as shown in FIG. 11, the process 1100 may include a step 1120 in which the driver 116 provides the user with access to decrypted content. In some embodiments, the driver 116 may provide the user with access to decrypted content via the user interface 118 or the network interface 120 of the access point 102).

In some embodiments, step 1106 may include the driver 116 storing the received access rights for the user with respect to the protected container 114 and/or the received passphrase for the protected container 114 (e.g., in a data storage system of the access point 102). In some embodiments, if the driver 116 receives from the user another protected data request that relates to content (e.g., raw data) of the same protected container 114, the protected data request and access process 1100 may skip steps 1104 and 1106 and proceed directly from step 1102 to step 1108 (because the driver 116 already has the access rights and/or passphrase for the protected container 114). In some embodiments, the process 1100 may include a step of determining whether the driver 116 has already received and stored access rights and/or passphrase for the protected container 114 that is performed after step 1102 but before proceeding to step 1104.

Although a particular order of steps is shown in FIG. 11, in some alternative embodiments, one or more of the steps may be performed in a different order. For example, in some alternative embodiments, one or more of steps 1108, 1110, and 1112 may be performed before or concurrently with one or more of steps 1104 and 1106.

In some embodiments, the process 1100 illustrated in FIG. 11 may relate to a protected data request that relates to a read operation. For a protected data request that relates to a write operation, the process 1100 may additionally or alternatively include steps of encrypting user supplied content, storing the encrypted contented to the protected container 114 in the storage system 104, and recording the write operation in the chain of custody ledger 216 of the protected container 114. In some embodiments, these write operation steps may be similar to steps 1116, 1114, and 1118, respectfully. For a protected data request that relates to a delete operation, the process 1100 may additionally or alternatively include removing encrypted data from the protected container 114. For a protected data request that relates a shred operation, the process 1100 may additionally or alternatively include overwriting encrypted data in a protected container 114 one or more times and then removing the overwritten data from the protected container 114.

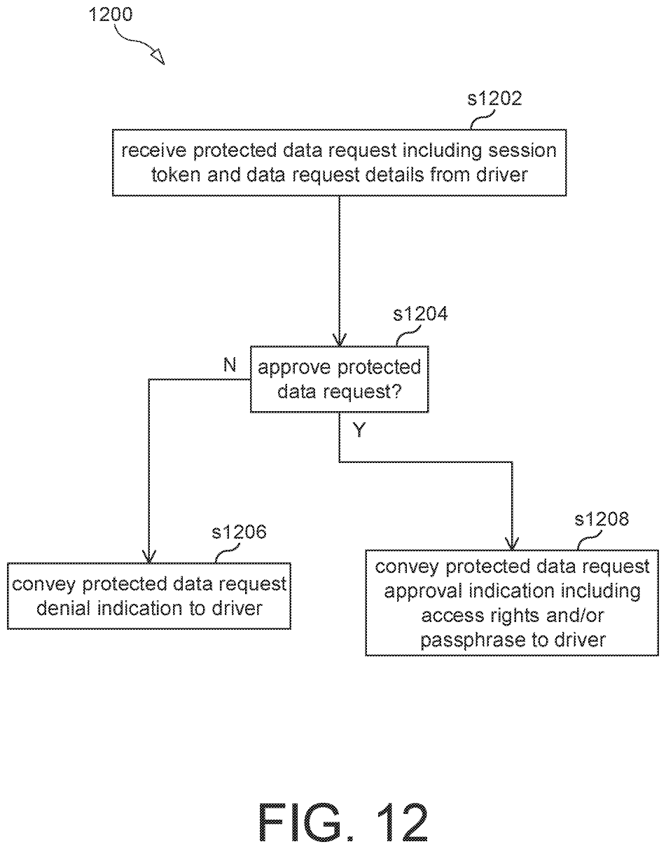

FIG. 12 is a flow chart illustrating a protected data request and access process 1200 according to some non-limiting embodiments of the invention. In some embodiments, the authentication system (AUTH) 106 may perform one or more steps of the process 1200. In some embodiments, one or more steps of the process 1200 may be performed in the protected data request and access step 408 of the process 400 shown in FIG. 4.

In some embodiments, as shown in FIG. 12, the process 1200 may include a step 1202 in which the AUTH 106 receives a protected data request conveyed by a driver 116 of the access point 102 (e.g., a computer system). In some embodiments, the AUTH 106 may receive the protected data request via a network interface of the AUTH 106 over a secure connection with the access driver 116. In some embodiments, the protected data request may include a session token (e.g., created by the AUTH 106 and conveyed to the driver 116 in step 808 of the login process 800) and a data request details. In some embodiments, the data request details may include an identification of the user access requester, an identification of a protected container 114, and/or an identification of the driver 116 of the access point 102. In some embodiments, the identification of the user access requester may be a universally unique identification (UUID) or a globally unique identification (GUID). In some embodiments, the container identification may be a UUID or a GUID. In some embodiments, the driver identification may be a UUID or a GUID.

In some embodiments, as shown in FIG. 12, the process 1200 may include a step 1204 in which the AUTH 106 determines whether to approve the protected data request. In some embodiments, determining whether to approve the protected data request may include determining that the session token of the received protected data request is active and/or determining that the user access requester has permission to make the protected data request. In some embodiments, the identification of the user access requester and/or the identification of the protected container 114 may be used to determine that the user access requester has permission to make the protected data request.

In some embodiments, determining whether the user access requester has permission to make the protected data request in step 1204 may include retrieving permissions 214 of the protected container 114 identified by the identification of the protected container 114. In some embodiments, determining whether the user access requester has permission to make the protected data request may include using the identification of the user access requester and the permissions 214 of the protected container 114. In some embodiments, determining whether the user access requester has permission to make the protected data request may include the AUTH 106 comparing access rights of the user access requester with the security level, permission level, and/or data privacy/compliance standards for the protected container 114 to determine if a user has access and what rights a user has to the content. In some embodiments, determining whether to approve the protected data request may additionally or alternatively include determining that the driver 116 of the access point 102 has permission to make the protected data request (e.g., using the identification of the driver 116 and the permissions 214 of the protected container 114). In some embodiments, the AUTH 106 may determine to not approve the protected data request in step 1204 if the permissions indicate that the user access requester and/or the driver 116 is not allowed to access the protected container 114.

In some embodiments, determining whether to approve the protected data request in step 1204 may additionally or alternatively include conveying details of the protected data request to the AI/ML system 110 and receiving a risk level indication conveyed by the AI/ML system 110. In some embodiments, the risk level indication may indicate a risk level associated with the protected data request. In some embodiments, determining to approve the protected data request may include determining that the risk level associated with the protected data request is acceptable. In some embodiments, determining that the risk level is acceptable may include comparing the received risk level indication against the acceptable risk levels to determine that the protected data request falls within acceptable risk parameters. In some embodiments, the AUTH 106 may determine to not approve the protected data request in step 1204 if the risk level associated with the protected data request is not acceptable. In some embodiments, the user access approval indication may include a session duration based on the received risk level indication. In some aspects, data access requests that produce higher calculated risk indications may result in shorter session times, and data access requests that produce lower calculated risk indications may result in longer session times.

In some embodiments, the protected data request may include a protected data request hash. In some embodiments, determining whether to approve the protected data request in step 1204 may include creating a hash of one or more of the details of the protected data request and determining whether the created hash matches the received protected data request hash. In some embodiments, the AUTH 106 may determine to not approve the protected data request in step 1204 if the created hash does not match the received protected data request hash.

In some embodiments, as shown in FIG. 12, the process 1200 may include a step 1206 in which the AUTH 106 conveys a protected data request denial indication to the driver 116 of the access point 102. In some embodiments, the process 1200 may proceed from step 1204 to step 1206 if the AUTH 106 determines to not approve the protected data request in step 1204. In some embodiments, if the AUTH 106 conveys a protected data request denial indication, the user is not allowed access to the requested protected data. In some embodiments, the AUTH 106 may convey the protected data request denial indication via the network interface of the AUTH 106 over the secure connection.

In some embodiments, as shown in FIG. 12, the process 1200 may include a step 1208 in which the AUTH 106 conveys a protected data request approval indication to the driver 116 of the access point 102. In some embodiments, the protected data request approval indication may include access rights for the user with respect to the protected container and/or a passphrase for the protected container 114 (e.g., the passphrase received in step 1010 of the protected container commissioning process 1000). In some embodiments, the process 1200 may proceed from step 1204 to step 1208 if the AUTH 106 determines to approve the protected data request in step 1206. In some embodiments, the AUTH 106 may convey the protected data request approval indication via the network interface of the AUTH 106 over the secure connection.

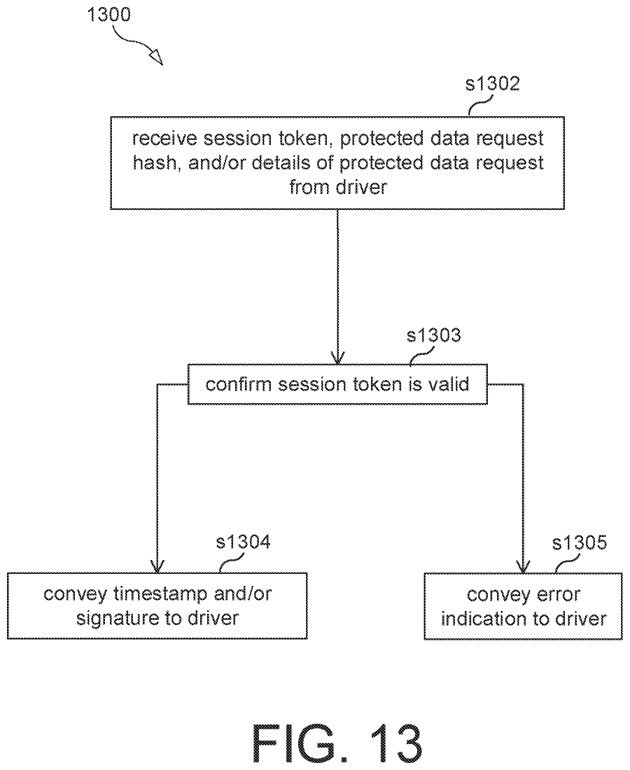

FIG. 13 is a flow chart illustrating a protected data request and access process 1300 according to some non-limiting embodiments of the invention. In some embodiments, the time stamp authority (TSA) system 108 may perform one or more steps of the process 1300. In some embodiments, one or more steps of the process 1300 may be performed in the protected data request and access step 408 of the process 400 shown in FIG. 4.

In some embodiments, as shown in FIG. 13, the process 1300 may include a step 1302 in which the TSA system 108 receives a session token, protected data request hash, and/or details of the protected data request from the driver 116 of an access point 102 (e.g., via a network interface of the TSA system 108 over a secure connection with the driver 116).

In some embodiments, as shown in FIG. 13, the process 1300 may include a step 1303 in which the TSA system 108 confirms that the session token received in step 1302 is valid. In some embodiments, a session token may be valid if it has not expired and has not been revoked. In some embodiments, the step 1303 may include the TSA system 108 conveying the session token to the AUTH 106 and receiving from AUTH 106 an indication whether the session token is valid. In some embodiments, if the TSA system 108 confirms that the session token is valid, the process 1300 may proceed from the step 1303 to a step 1304. In some embodiments, the TSA system 108 determines that the session token is not valid, the process 1300 may proceed from the step 1303 to a step 1305.

In some embodiments, as shown in FIG. 13, the process 1300 may include a step 1304 in which the TSA system 108 conveys a timestamp and/or a signature to the driver 116 of the access point 102 (e.g., via a network interface of the TSA system 108 over the secure connection with the driver 116). In some embodiments, the process 1300 may include a step 1305 in which the TSA system 108 conveys an error indication to the driver 116 of the access point 102 (e.g., via a network interface of the TSA system 108 over the secure connection with the driver 116).

Aspects of the present invention have been fully described above with reference to the drawing figures. Although the invention has been described based upon these preferred aspects, it would be apparent to those of skill in the art that certain modifications, variations, and alternative constructions could be made to the described aspects within the spirit and scope of the invention.

What is claimed is:

1. A method performed by an authentication system, the method comprising:
conveying a driver commission identifier to a driver of a computer system;
receiving a user access request conveyed by the driver of the computer system, wherein the user access request includes user credentials of a user access requester and the driver commission identifier, and the user credentials include a username of the user access requester;
determining that the user credentials of the user access requester are authentic;
in response to determining that the user credentials are authentic, creating a session token and conveying a user access approval indication to the driver of the computer system, wherein the user access approval indication includes the session token;
receiving a protected data request conveyed by the driver of the computer system, wherein the protected data request includes an identification of the user access requester, the session token, and an identification of a protected container;
determining to approve the protected data request, wherein determining to approve the protected data request comprises:
determining that the session token of the received protected data request is active; and
determining that the user access requester has permission to make the protected data request, wherein the identification of the user access requester and the identification of the protected container are used to determine that the user access requester has permission to make the protected data request; and
in response to determining to approve the protected data request, conveying a protected data request approval indication to the driver of the computer system.

2. The method of claim 1, further comprising:
receiving a username of a driver commissioning requester from the driver of the computer system;
determining that the username of the driver commissioning requester is valid;
determining that the driver commissioning requester has authority to commission the driver of the computer system; and
in response to determining that the username of the driver commissioning requester is valid and that the driver commissioning requester has authority to commission the driver of the computer system, generating the driver commission identifier and conveying the driver commission identifier to the driver of the computer system.

3. The method of claim 2, wherein determining that the username of the driver commissioning requester is valid comprises:
comparing the username of the driver commissioning requester to a list of valid usernames, and
determining the username of the driver commissioning requester to be associated with the computer system on which a driver commission request is being made.

4. The method of claim 2, further comprising:
generating a public key and private key pair, wherein the public key is unique to the driver commission identifier; and
conveying the public key to the driver of the computer system.

5. The method of claim 4, further comprising:
receiving an encrypted packet conveyed by the driver of the computer system, wherein the encrypted packet includes the username of the driver commission requester, a hardware identifier that uniquely identifies the computer system, and the driver commission identifier; and
decrypting the encrypted packet using the private key.

6. The method of claim 5, wherein the encrypted packet further includes a public key unique to the driver of the computer system.

7. The method of claim 5, further comprising conveying a commissioning approval indication to the driver commission requester.

8. The method of claim 7, wherein the commissioning approval indication is a first commissioning approval indication including a one-time authentication secret, and the method further comprises:
receiving a packet conveyed by the driver of the computer system, wherein the packet includes an authentication code generated using the one-time authentication secret, the hardware identifier, and the driver commission identifier;
validating the authentication code, the hardware identifier, and the driver commission identifier; and
in response to validating the authentication code, the hardware identifier, and the driver commission identifier, conveying a second commissioning approval indication to the driver of the computer system.

9. The method of claim 1, wherein the user access approval indication further includes an identification of the user access requester.

10. The method of claim 1, wherein the protected data request approval indication includes a passphrase of the protected container.

11. The method of claim 1, wherein the protected data request approval indication includes access rights and permissions to the protected container.

12. The method of claim 1, wherein determining that the user access requester has permission to make the protected data request comprises:
retrieving permissions of the protected container identified by the identification of the protected container; and
using the identification of the user access requester and the permissions of the protected container to determine that the user access requester has permission to make the protected data request.

13. The method of claim 1, wherein the protected data request includes an identification of the driver of the computer system, and determining to approve the protected data request further comprises determining that the driver of the computer system has permission to make the protected data request.

14. The method of claim 13, wherein determining that the driver of the computer system has permission to make the protected data request comprises:
retrieving permissions of the protected container identified by the identification of the protected container; and
using the identification of the driver and the permissions of the protected container to determine that the driver of the computer system has permission to make the protected data request.

15. The method of claim 1, wherein determining to approve the protected data request further comprises:
conveying details of the user access requester, the protected data request, and the driver of the computer system to an artificial intelligence and/or machine learning (AI/ML) system; and
receiving a risk level indication conveyed by the AI/ML, system, wherein the risk level indication indicates a risk level associated with the protected data request.

16. The method of claim 15, further comprising using the AI/ML system to determine the risk level, wherein determining the risk level comprises receiving data requester behavior metrics from the driver of the computer system, writing the data requester behavior metrics to a database of the AI/ML, and processing the data requester behavior metrics using one or more AI/ML algorithms.

17. The method to claim 15, wherein determining to approve the protected data request further comprises comparing the received risk level indication against the acceptable risk levels to determine that the protected data request falls within acceptable risk parameters.

18. The method of claim 15, wherein the user access approval indication further includes a session duration based on the received risk level indication.

19. The method of claim 1, wherein the protected data request further includes a protected data request hash, and determining to approve the protected data request further comprises:
creating a hash of one or more of the details of the protected data request; and
determining that the created hash matches the protected data request hash.

20. An authentication system adapted to:
convey a driver commission identifier to a driver of a computer system;
receive a user access request conveyed by the driver of the computer system, wherein the user access request includes user credentials of a user access requester and the driver commission identifier, and the user credentials include a username of the user access requester;
determine that the user credentials of the user access requester are authentic;
in response to determining that the user credentials are authentic, create a session token and convey a user access approval indication to the driver of the computer system, wherein the user access approval indication includes the session token;
receive a protected data request conveyed by the driver of the computer system, wherein the protected data request includes an identification of the user access requester, the session token, and an identification of a protected container;
determine to approve the protected data request, wherein determining to approve the protected data request comprises:
determining that the received session token is active; and
determining that the user access requester has permission to make the protected data request, wherein the identification of the user access requester and the identification of the protected container are used to determine that the user access requester has permission to make the protected data request; and
in response to determining to approve the protected data request, convey a protected data request approval indication to the driver of the computer system.
